(19) United States
(12) Patent Application Publication
(10) Pub. No.: US 2023/0070687 A1
(43) Pub. Date: Mar. 9, 2023

(54) IMMERSION MICROSCOPE OBJECTIVE

(71) Applicant: Evident Corporation, Kamiina-gun (JP)

(72) Inventor: Takashi KASAHARA, Tokyo (JP)

(73) Assignee: Evident Corporation, Kamiina-gun (JP)

(21) Appl. No.: 17/890,010

(22) Filed: Aug. 17, 2022

(30) Foreign Application Priority Data
Aug. 27, 2021 (JP) 2021-138763

(51) Int. Cl. G02B 21/02

(52) U.S. Cl. CPC G02B 21/02; G02B 21/025; G02B 27/0025

(57) ABSTRACT

An immersion objective includes a first lens group including a meniscus lens, a second lens group including a cemented lens and having a positive power, and a third lens group having a negative power. The third lens group is formed of a front group having a concave surface on a most image side and a back group having a concave surface on the most object side. Even when any of a plurality of immersion liquids used together with the immersion microscope objective is used, an amount of chromatic aberration at each of wavelengths in a range from 435.18 nm to 656.13 nm, which has an e-line as a reference, is smaller than a magnitude of depth of focus of the immersion microscope objective at the wavelength. The immersion microscope objective satisfies a following conditional expression.

0.64≤NA×WD≤3.5 (1)

### CROSS REFERENCE TO RELATED APPLICATIONS

This application is based upon and claims the benefit of priority from prior Japanese Patent Application No. 2021-138763, filed Aug. 27, 2021, the entire contents of which are incorporated herein by this reference.

### TECHNICAL FIELD

The disclosure herein relates to an immersion microscope objective.

### BACKGROUND

In a microscope, there is an increasing opportunity to observe a three dimensional-specimen typified by a spheroid. In observation of a three-dimensional specimen, it is not easy to observe a deep portion of the specimen due to scattering inside the specimen. Therefore, for example, as described in JP 2014-160213 A, there has been proposed a technique for observing a three-dimensional specimen to a deep portion by using a correction collar. Various approaches for clearing a specimen have also been developed. The evolution of a clearing solution has also enabled the use of immunostaining, which allows simultaneous fluorescence observation at multiple wavelengths even in a cleared specimen.

### SUMMARY

An immersion microscope objective according to one aspect of the present invention is an immersion microscope objective having a magnification of 35 times or less in which includes, in order from an object side, a first lens group including a meniscus lens, a second lens group including a cemented lens and having a positive refractive power for converting a divergent pencil of light into a convergent pencil of light, and a third lens group having a negative refractive power as a whole. The third lens group is formed of, in order from the object side, a front group having a concave surface having a negative refractive power on the most image side and a back group having a concave surface having a negative refractive power on the most object side. The immersion microscope objective is that even when any of a plurality of immersion liquids used together with the immersion microscope objective is used, an amount of chromatic aberration at each of wavelengths in a range from 435.18 nm to 656.13 nm, which has an e-line as a reference, is smaller than a magnitude of depth of focus of the immersion microscope objective at the wavelength, and satisfies a following conditional expression.

0.64≤NA×WD≤3.5 (1)

where NA is a numerical aperture on the object side of the immersion microscope objective. WD is a working distance of the immersion microscope objective.

### BRIEF DESCRIPTION OF DRAWINGS

The present invention will be more apparent from the following detailed description when the accompanying drawings are referenced.

FIG. 1 is a cross-sectional view of an objective according to a first embodiment of the present invention in a first state;

FIG. 2 is a cross-sectional view of the objective according to the first embodiment of the present invention in a second state;

FIG. 3 is a cross-sectional view of a tube lens;

FIG. 4 is a graph illustrating the amount of chromatic aberration of an optical system formed of the objective and the tube lens;

FIGS. 5A to 5D are aberration diagrams of the optical system formed of the objective and the tube lens in the first state;

FIGS. 6A to 6D are aberration diagrams of the optical system formed of the objective and the tube lens in the second state;

FIG. 7 is a cross-sectional view of an objective according to a second embodiment of the present invention in a first state;

FIG. 8 is a cross-sectional view of the objective according to the second embodiment of the present invention in a second state;

FIG. 9 is a graph illustrating the amount of chromatic aberration of an optical system formed of the objective and the tube lens;

FIGS. 10A to 10D are aberration diagrams of the optical system formed of the objective and the tube lens in the first state;

FIGS. 11A to 11D are aberration diagrams of the optical system formed of the objective and the tube lens in the second state;

FIG. 12 is a cross-sectional view of an objective according to a third embodiment of the present invention in a first state;

FIG. 13 is a cross-sectional view of the objective according to the third embodiment of the present invention in a second state;

FIG. 14 is a graph illustrating the amount of chromatic aberration of an optical system formed of the objective and the tube lens;

FIGS. 15A to 15D are aberration diagrams of the optical system formed of the objective and the tube lens in the first state;

FIGS. 16A to 16D are aberration diagrams of the optical system formed of the objective and the tube lens in the second state;

FIG. 17 is a cross-sectional view of an objective according to a fourth embodiment of the present invention in a first state;

FIG. 18 is a cross-sectional view of the objective according to the fourth embodiment of the present invention in a second state;

FIG. 19 is a cross-sectional view of the objective according to the fourth embodiment of the present invention in a third state;

FIG. 20 is a cross-sectional view of the objective according to the fourth embodiment of the present invention in a fourth state;

FIG. 21 is a graph illustrating the amount of chromatic aberration of an optical system formed of the objective and the tube lens;

FIGS. 22A to 22D are aberration diagrams of the optical system formed of the objective and the tube lens in the first state;

FIGS. 23A to 23D are aberration diagrams of the optical system formed of the objective and the tube lens in the second state;

FIGS. 24A to 24D are aberration diagrams of the optical system formed of the objective and the tube lens in the third state;

FIGS. 25A to 25D are aberration diagrams of the optical system formed of the objective and the tube lens in the fourth state;

FIG. 26 is a cross-sectional view of an objective according to a fifth embodiment of the present invention in a first state;

FIG. 27 is a cross-sectional view of the objective according to the fifth embodiment of the present invention in a second state;

FIG. 28 is a graph illustrating the amount of chromatic aberration of the optical system formed of the objective and the tube lens;

FIGS. 29A to 29D are aberration diagrams of the optical system formed of the objective and the tube lens in the first state;

FIGS. 30A to 30D are aberration diagrams of the optical system formed of the objective and the tube lens in the second state;

FIG. 31 is a cross-sectional view of an objective according to a sixth embodiment of the present invention in a first state;

FIG. 32 is a cross-sectional view of the objective according to the sixth embodiment of the present invention in a second state;

FIG. 33 is a graph illustrating the amount of chromatic aberration of the optical system formed of the objective and the tube lens;

FIGS. 34A to 34D are aberration diagrams of an optical system formed of the objective and the tube lens in the first state;

FIGS. 35A to 35D are aberration diagrams of the optical system formed of the objective and the tube lens in the second state;

FIG. 36 is a cross-sectional view of an objective according to a seventh embodiment of the present invention in a first state;

FIG. 37 is a cross-sectional view of the objective according to the seventh embodiment of the present invention in a second state;

FIG. 38 is a graph illustrating the amount of chromatic aberration of an optical system formed of the objective and the tube lens;

FIGS. 39A to 39D are aberration diagrams of the optical system formed of the objective and the tube lens in the first state; and

FIGS. 40A to 40D are aberration diagrams of the optical system formed of the objective and the tube lens in the second state.

### DESCRIPTION

Currently, various clearing solutions have been developed, and the substances used for clearing are also varied. For this reason, the clearing solutions vary in refractive index and dispersion. Therefore, regardless of clearing solution, it is not easy to correct spherical aberration and chromatic aberration caused by the refractive index or dispersion at the same time with any clearing solution.

Further, in the case where an immersion microscope objective is used for observation, if an immersion liquid that contains a volatile component such as water or absorbs moisture and is difficult to maintain uniformity is used, the refractive index of the immersion liquid also changes with time. Since the spherical aberration changes with time due to this influence, it is more difficult to exhibit sufficient performance necessary for observation and to maintain the performance during observation with one immersion microscope objective.

In view of the above circumstances, embodiments of the present application will be described below.

An objective according to an embodiment of the present application will be described. The objective according to the present embodiment (hereinafter simply referred to as an objective) is an infinity-corrected microscope objective used in combination with a tube lens. The objective is a so-called immersion microscope objective used when a specimen is observed in a state where an immersion liquid is interposed between the specimen and the objective.

The objective has a low magnification, more specifically a magnification of 35 times or less. In other words, if the focal length of the objective is f and the focal length of the tube lens used in combination with the objective is ft, the relationship ft/f≤35 is obtained.

The objective is designed such that the chromatic aberration is satisfactorily corrected in a wide wavelength range. Specifically, the objective is designed such that at least the amount of chromatic aberration at each of the wavelengths which has the e-line of 546.07 nm as a reference is smaller than the magnitude of depth of focus of the objective at the wavelength in the range of 435.18 nm to 656.13 nm even when various immersion liquids are used. Note that the depth of focus DOF mentioned here refers to a depth of focus on the object side, that is, a depth of field, and may be calculated by DOF=n×λ/(2×NA²). Where n is the refractive index of the immersion liquid, λ is the wavelength, and NA is the numerical aperture on the object side of the objective.

The various immersion liquids used together with the objective are not particularly limited. In the following embodiments, a case where two or more kinds of immersion liquids are selected and used from the following five kinds of immersion liquids will be described as an example. The objective is desirably designed so as to satisfy the above condition in terms of chromatic aberration even when such various immersion liquids are used. Specifically, the objective is desirably designed so as to satisfy the above condition even if at least one of the refractive indices or the Abbe numbers of the immersion liquids differs by 5% or more. Note that the refractive indices Nd and the Abbe numbers vd of these immersion liquids are as follows.

Immersion liquid A: Nd=1.49306, νd=52.67

Immersion liquid B: Nd=1.4042, νd=52.02

Immersion liquid C: Nd=1.33276, νd=55.38

Immersion liquid D: Nd=1.37919, νd=52.40

Immersion liquid E: Nd=1.49306, νd=55.50

The objective is formed of, in order from the object side, a first lens group, a second lens group having a positive refractive power, and a third lens group having a negative refractive power. The first lens group has, for example, a positive refractive power.

The first lens group includes a meniscus lens. The meniscus lens is disposed with a concave surface thereof facing the object side, within the first lens group. The second lens group includes a cemented lens and converts a divergent pencil of light from the first lens group into a convergent pencil of light. In other words, the most object-side lens (or lens component) that converts the divergent pencil of light from the object point into the convergent pencil of light is the most object-side lens (or lens component) of the second lens group. The boundary between the first lens group and the second lens group can be specified by the above features.

The third lens group is formed of, in order from the object side, a front group and a back group having concave surfaces facing each other. In other words, the third lens group is formed of a front group having a concave surface having a negative refractive power on the most image side and a back group having a concave surface having a negative refractive power on the most object side. Note that the front group is formed of, for example, a single lens component.

In this specification, a pencil of light refers to a bundle of light rays emitted from one point (object point) of an object. The lens component refers to a lens block in which only two surfaces, i.e., an object-side surface and an image-side surface among lens surfaces through which a light ray from an object point passes are in contact with air (or an immersion liquid) regardless of whether the lens is a single lens or a cemented lens.

The first lens group and the second lens group refract a divergent pencil of light from an object point little by little, convert the pencil of light into a convergent pencil of light, and make the convergent pencil of light incident on the third lens group. The third lens group converts the convergent pencil of light from the second lens group into a divergent pencil of light at the concave surfaces having a strong negative refractive power disposed to face each other, then converts the divergent pencil of light into a parallel pencil of light, and emits the parallel pencil of light.

The first lens group and the second lens group refract a divergent pencil of light from the object point little by little, convert the divergent pencil of light into a convergent pencil of light, and make the convergent pencil of light incident on the third lens group, so that the marginal ray height inside the third lens group can be made lower than the marginal ray height inside the second lens group. Thus, the Petzval sum can be effectively corrected by the third lens group having a negative refractive power, and as a result, the field curvature can be satisfactorily corrected over a wide field of view. The chromatic aberration can be satisfactorily corrected by including the cemented lens in the second lens group having a high ray height.

The above-described lens configuration can allow the objective to realize a high numerical aperture capable of observing a cell detail at a low magnification of 35 times or less and a long working distance capable of observing a deep portion of a specimen.

The objective is configured to satisfy the following conditional expression (1).

0.64≤NA×WD≤3.5 (1)

where NA is the numerical aperture on the object side of the objective. WD is the working distance of the objective.

The conditional expression (1) defines the numerical aperture and the working distance of the objective. When the conditional expression (1) is satisfied, for example, in a confocal microscope, even when various immersion liquids having different refractive indices and Abbe numbers are used, it is possible to perform fluorescence observation in which spherical aberration and chromatic aberration are corrected at the same time with bright and high resolution down to a deep portion of a specimen.

If NA×WD exceeds the upper limit value, at least one of the numerical aperture and the working distance becomes too large. The larger the numerical aperture, the more difficult it is to correct chromatic aberration. The amount of chromatic aberration increases in proportion to the length of the working distance. Therefore, if the working distance is too long, it is difficult to correct chromatic aberration when various immersion liquids having different Abbe numbers are used. If NA×WD falls below the lower limit value, at least one of the numerical aperture and the working distance becomes too small. If the numerical aperture is small, sufficient resolution cannot be obtained, and brightness in fluorescence observation is also insufficient. If the working distance is too short, it is difficult to observe a deep portion of a specimen when a culture vessel having a thick bottom surface is used or when the specimen is thick.

The objective may be configured to satisfy the following conditional expression (1-1) instead of the conditional expression (1).

0.65≤NA×WD≤3.1 (1-1)

The objective configured as described above can realize a high numerical aperture and a long working distance at a low magnification, and can further correct chromatic aberration in a wide band. Therefore, even when various solutions having different refractive indices and Abbe numbers are used as an immersion liquid, a culture solution, a clearing solution, and others, the spherical aberration and the chromatic aberration can be satisfactorily corrected. Therefore, the objective can exhibit sufficient performance even when various solutions are used.

A desirable configuration of the objective will be described below.

The objective desirably has a correction collar. Various amounts of spherical aberration may be corrected by moving a moving group included in the objective by the correction collar. The correction collar may be controlled by an automatic correction collar device as described in JP 2014-160213 A, whereby spherical aberration and chromatic aberration may be automatically corrected in response to various solutions having different refractive indices and Abbe numbers.

The objective desirably includes only one moving group in any one of the first lens group, the second lens group, and the third lens group. In this case, spherical aberration can be corrected with high accuracy even accuracy even if a simple structure is adopted for a structure for moving the moving groups, as compared with a case where a plurality of moving groups is interlocked and controlled. In particular, the second lens group desirably includes a moving group. When the moving group is included within the second lens group having a high ray height, the spherical aberration can be easily corrected.

The first lens group desirably includes a cemented lens on the most object side. It is desirable that the first cemented lens, which is the cemented lens disposed on the most object side in the first lens group, is a two-piece cemented lens that includes, in order from the object side, the first lens and a meniscus lens and that these lenses are cemented together.

The second lens group desirably includes a plurality of cemented lenses, and in particular, any one of the lenses is desirably a moving group. Thus, since the spacing between the cemented lenses can be changed, it is easy to correct spherical aberration and chromatic aberration at the same time.

Further, at least one of the plurality of cemented lenses included in the second lens group is desirably a positive-negative-positive three-piece cemented lens. Thus, it is possible to change the lens spacing on the object side or the image side of the positive-negative-positive three-piece cemented lens having a large chromatic aberration correction effect disposed within the second lens group having a high ray height, and as a result, it is easier to correct spherical aberration and chromatic aberration at the same time.

The back group of the third lens group has at least one air contact surface between a lens surface closest to the object side and a lens surface closest to the image side of the back group. In other words, the back group includes two or more lens components. Thus, since the correlation between coma aberration and chromatic aberration of magnification is reduced, it is easy to correct coma aberration and chromatic aberration of magnification at the same time.

The objective desirably satisfies at least one of the following conditional expressions (2) to (5).

0.25≤1/|(iνd1−iνd2)×WD|≤10 [mm⁻¹] (2)

−20≤(νdG1−νdG2)/R1≤−5 [mm⁻¹] (3)

0.003≤|(TANF−TANC)/TANd|≤0.020 (4)

0.3≤(νdZ1−νdZ2)/FZ1≤3 [mm⁻¹] (5)

Where iνd1 is the Abbe number of the immersion liquid having the lowest refractive index among the plurality of immersion liquids used together with the objective. iνd2 is the Abbe number of the immersion liquid having the highest refractive index among the plurality of immersion liquids used together with the objective. νdG1 is an Abbe number of the first lens constituting the first cemented lens. νdG2 is the Abbe number of the meniscus lens constituting the first cemented lens. TANF is the ratio of the longitudinal direction cosine to the transverse direction cosine of the axial marginal ray for the F-line (the transverse direction cosine/the longitudinal direction cosine), and is the tangent indicating the direction at the time of emission from the lens surface closest to the image side of the moving group. TANC is the ratio of the longitudinal direction cosine to the transverse direction cosine of the axial marginal ray for the C-line (the transverse direction cosine/the longitudinal direction cosine), and is the tangent indicating the direction at the time of emission from the lens surface closest to the image side of the moving group. TANd is the ratio of the longitudinal direction cosine to the transverse direction cosine of the axial marginal ray for the d-line (the transverse direction cosine/the longitudinal direction cosine), and is the tangent indicating the direction at the time of emission from the lens surface closest to the image side of the moving group. νdZ1 is the highest Abbe number among the Abbe numbers of the one or more positive lenses included in the moving group that is a cemented lens. νdZ2 is the lowest Abbe number among the Abbe numbers of the one or more negative lenses included in the moving group that is a cemented lens. FZ1 is the focal length of the moving group.

The conditional expression (2) defines the Abbe number difference between the immersion liquid having the maximum refractive index and the immersion liquid having the minimum refractive index to be used together with the objective. The amount of occurrence of spherical aberration and chromatic aberration differs for each immersion liquid, and a larger correction amount is required as the working distance becomes longer. When the conditional expression (2) is satisfied, the ratio of the difference in dispersion between the two immersion liquids at which the maximum refractive index difference expected to be used occurs to the working distance is optimized, and as a result, the spherical aberration and chromatic aberration can be sufficiently corrected even in an objective having a high numerical aperture.

If 1/|(iνd1−iνd2)×WD| exceeds the upper limit value, the working distance is too short, and thus it is difficult to observe the specimen to a deep portion. If 1/|(iνd1−iνd2)×WD| falls below the lower limit value, the difference in dispersion between the two immersion liquids at which the maximum refractive index difference occurs is too large or the working distance is too long. Therefore, chromatic aberration excessively occurs with respect to spherical aberration, and thus it is difficult to correct spherical aberration and chromatic aberration at the same time.

The conditional expression (3) defines the relationship between the Abbe number and the cemented surface of the cemented lens disposed on the most object side of the objective. An objective having a high numerical aperture and a low magnification is required to have good aberration performance up to a high image height. When the conditional expression (3) is satisfied, the occurrence of field curvature can be suppressed by correcting the Petzval sum by the cemented lens closest to the object side, so that it is possible to maintain favorable performance up to a high image height.

If (νdG1−νdG2)/R1 exceeds the upper limit value, a large chromatic aberration occurs in the cemented lens closest to the object side. Therefore, the chromatic aberration cannot be completely corrected by the lens group subsequent to the cemented lens. In particular, when an immersion liquid having a different Abbe number is used, it is difficult to sufficiently cope with a change in chromatic aberration occurring in light emitted from the cemented lens even by changing the lens spacing by the correction collar. As a result, it is difficult to correct spherical aberration and chromatic aberration at the same time. If (νdG1−νdG2)/R1 falls below the lower limit value, the Petzval sum cannot be corrected at the cemented surface of the cemented lens closest to the object side, and as a result, the field curvature cannot be corrected. Therefore, it is difficult to maintain good performance up to a high image height.

The conditional expression (4) defines the relationship between the emission directions of the light of each color from the moving group. When the conditional expression (4) is satisfied, the difference in the emission directions of the light of each color is optimized, and it is possible to change chromatic aberration in addition to spherical aberration by changing the lens spacing. Therefore, even when various immersion liquids having different refractive indices and Abbe numbers are used, both spherical aberration and chromatic aberration can be corrected at the same time. Note that the conditional expression (4) is desirably satisfied regardless of the position of the moving group.

If |(TANF−TANC)/TANd| exceeds the upper limit value, the difference in the emission directions of each color from the moving group is too large, and thus the correction of chromatic aberration becomes excessive with respect to spherical aberration. Therefore, it is difficult to correct both spherical aberration and chromatic aberration at the same time. If |(TANF−TANC)/TANd| falls below the lower limit value, the difference in the emission directions of each color from the moving group is too small, and thus the correction of chromatic aberration becomes insufficient with respect to spherical aberration. Therefore, it is difficult to correct both spherical aberration and chromatic aberration at the same time.

The conditional expression (5) defines the relationship between the Abbe number difference within the moving group and the focal length of the moving group. When the conditional expression (5) is satisfied, it is possible to change the chromatic aberration correction amount on the cemented surface of the cemented lens which is the moving group within an appropriate range by changing the lens spacing. Therefore, even when various immersion liquids having different refractive indices and Abbe numbers are used, both spherical aberration and chromatic aberration can be corrected at the same time.

If (νdZ1−νdZ2)/FZ1 exceeds the upper limit value, the difference in the Abbe number within the moving group is too large with respect to the focal length of the moving group, so that the chromatic aberration correction amount on the cemented surface of the moving group is large. Therefore, the chromatic aberration is excessively corrected with respect to the spherical aberration, and it is difficult to correct both spherical aberration and chromatic aberration at the same time. If (νdZ1−νdZ2)/FZ1 falls below the lower limit value, the difference in the Abbe number within the moving group is too small with respect to the focal length of the moving group, so that the chromatic aberration correction amount on the cemented surface of the moving group is small. Therefore, chromatic aberration is insufficiently corrected with respect to spherical aberration, and it is difficult to correct both spherical aberration and chromatic aberration at the same time.

Note that the objective may be configured to satisfy the following conditional expression (2-1) instead of the conditional expression (2). The objective may be configured to satisfy the following conditional expression (3-1) instead of the conditional expression (3). The objective may be configured to satisfy the following conditional expression (4-1) instead of the conditional expression (4). The object lens may be configured to satisfy the following conditional expression (5-1) instead of the conditional expression (5).

0.3≤1/|(iνd1−iνd2)×WD|≤5 [mm⁻¹] (2-1)

−18≤(νdG1−νdG2)/R1≤−7 [mm⁻¹] (3-1)

0.0035≤|(TANF−TANC)/TANd|≤0.019 (4-1)

0.45≤(νdZ1−νdZ2)/FZ1≤2 [mm⁻¹] (5-1)

Embodiments of the objective described above will be specifically described below.

### First Embodiment

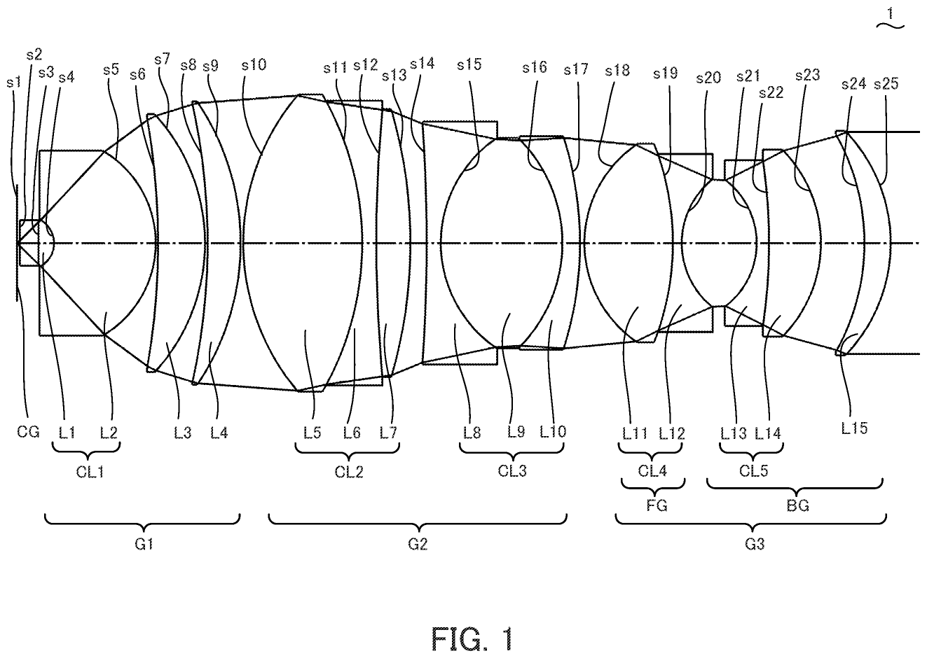

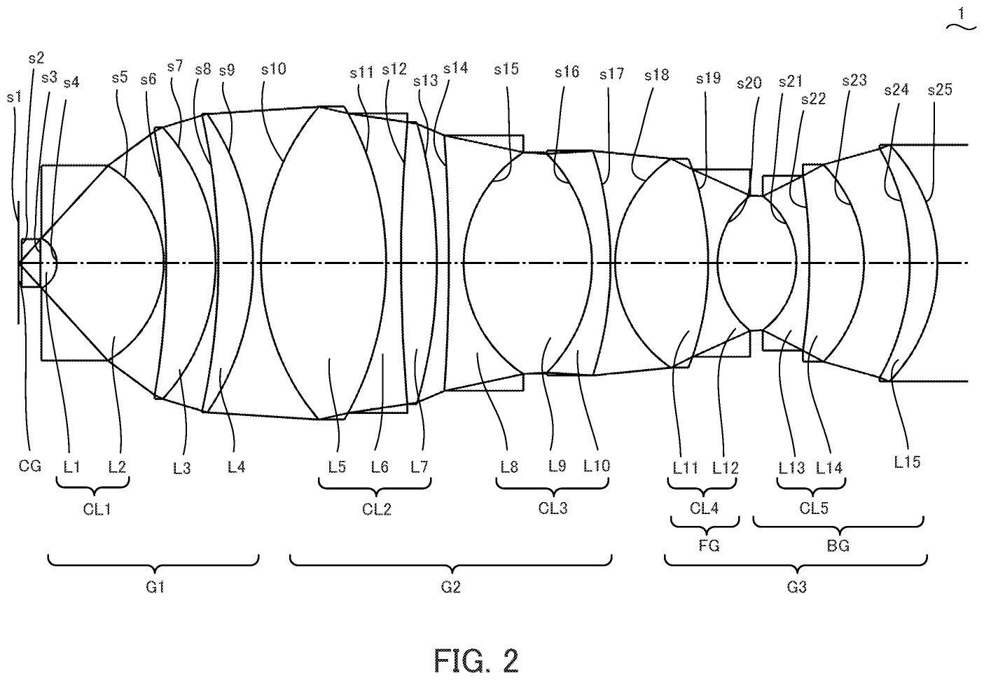

FIGS. 1 and 2 are cross-sectional views of an objective 1 according to the present embodiment. FIGS. 1 and 2 illustrate states in which the positions of the moving groups in the objective 1 are different from each other. In the present embodiment, the state illustrated in FIG. 1 is referred to as a first state, and the state illustrated in FIG. 2 is referred to as a second state.

The objective 1 is formed of, in order from the object side, a first lens group G1 having a positive refractive power, a second lens group G2 having a positive refractive power, and a third lens group G3 having a negative refractive power. Note that the objective 1 is a liquid immersion objective for microscope.

The first lens group G1 includes, in order from the object side, a cemented lens CL1, a lens L3 which is a meniscus lens having a concave surface facing the object side, and a lens L4 which is a meniscus lens having a concave surface facing the object side. The cemented lens CL1 is a two-piece cemented lens and is formed of, in order from the object side, a lens L1 which is a plano-convex lens having a flat surface facing the object side and a lens L2 which is a meniscus lens having a concave surface facing the object side.

The second lens group G2 converts a divergent pencil of light from the first lens group G1 into a convergent pencil of light. The second lens group G2 includes, in order from the object side, a cemented lens CL2 which is a three-piece cemented lens and a cemented lens CL3 which is a three-piece cemented lens. The cemented lens CL2 is a moving group, is a positive-negative-positive three-piece cemented lens, and is formed of, in order from the object side, a lens L5 which is a biconvex lens, a lens L6 which is a biconcave lens, and a lens L7 which is a biconvex lens. The cemented lens CL3 is formed of, in order from the object side, a lens L8 which is a biconcave lens, a lens L9 which is a biconvex lens, and a lens L10 which is a meniscus lens having a concave surface facing the object side.

The third lens group G3 is formed of a front group FG (cemented lens CL4) and a back group BG (cemented lens CL5 and lens L15) having concave surfaces facing each other. The third lens group G3 includes, in order from the object side, a cemented lens CL4, a cemented lens CL5, and a lens L15 which is a meniscus lens having a concave surface facing the object side. The cemented lens CL4 is formed of, in order from the object side, a lens L11 which is a biconvex lens and a lens L12 which is a biconcave lens. The cemented lens CL5 is formed of, in order from the object side, a lens L13 which is a meniscus lens having a concave surface facing the object side and a lens L14 which is a meniscus lens having a concave surface facing the object side.

Various data of the objective 1 are as follows. Note that β is a magnification when the objective 1 is combined with a tube lens 10. NA_{ob} is the numerical aperture on the object side of the objective 1. f, f1, f2, and f3 are the focal length of the objective, the focal length of the first lens group G1, the focal length of the second lens group G2, and the focal length of the third lens group G3, respectively. Note that the reference wavelength is the d-line.

β≈30, f=6.0040 mm (first state), f=6.0932 mm (second state), f1=8.4228 mm, f2=40.8210 mm, f3=−79.2778 mm, NA=1.05, WD=1.050 mm (first state), WD=1.005 mm (second state), iνd1=52.02, iνd2=52.67, νdG1=64.140, νdG2=40.760, R1=−1.5250 mm, νdZ1=81.54, νdZ2=42.41, FZ1=22.636 mm

(first state) TANF=0.4134, TANC=0.4103, TANd=0.4112

(second state) TANF=0.4285, TANC=0.4253, TANd=0.4263

Lens data of the objective 1 is as follows. Note that INF in the lens data indicates infinity (∞).

Objective Lens 1

| s | r | d | nd | νd |
|---|---|---|---|---|
| 1 | INF | 0.1700 | 1.52397 | 54.41 |
| 2 | INF | D2 | NE2 | νD2 |
| 3 | INF | 0.8800 | 1.51633 | 64.14 |
| 4 | −1.5250 | 5.7678 | 1.88300 | 40.76 |
| 5 | −6.0950 | 0.1324 | | |
| 6 | −40.7697 | 2.6615 | 1.56907 | 71.30 |
| 7 | −10.8388 | 0.1500 | | |
| 8 | −36.5514 | 1.8711 | 1.56907 | 71.30 |
| 9 | −14.3560 | D9 | | |
| 10 | 13.0111 | 6.7427 | 1.49700 | 81.54 |
| 11 | −16.9144 | 0.8000 | 1.63775 | 42.41 |
| 12 | 83.9412 | 1.9400 | 1.49700 | 81.54 |
| 13 | −27.0247 | D13 | | |
| 14 | −95.7974 | 0.8000 | 1.63775 | 42.41 |
| 15 | 7.1735 | 6.9150 | 1.43875 | 94.66 |
| 16 | −8.3854 | 1.0000 | 1.63775 | 42.41 |
| 17 | −19.9557 | 0.2500 | | |
| 18 | 6.7932 | 5.0145 | 1.56907 | 71.30 |
| 19 | −15.5037 | 0.5054 | 1.63775 | 42.41 |
| 20 | 4.6620 | 4.2500 | | |
| 21 | −4.5224 | 0.7000 | 1.88300 | 40.76 |
| 22 | −32.7935 | 2.9403 | 1.74100 | 52.64 |
| 23 | −7.5555 | 2.4696 | | |
| 24 | −12.5960 | 1.4890 | 1.85478 | 24.80 |
| 25 | −9.1732 | 120.0000 | | |

Where s indicates a surface number, r indicates a radius of curvature (mm), d indicates a surface spacing (mm), nd indicates a refractive index, and νd indicates an Abbe number. Note that the reference wavelength is the d-line (587.56 nm). These symbols are the same in the following embodiments. Note that surfaces indicated by surface numbers s1 and s2 are an object-side surface of a cover glass CG and an image-side surface of the cover glass CG, respectively. Surfaces indicated by surface numbers s3 and s25 are a lens surface closest to the object side and a lens surface closest to the image side of the objective 1, respectively. For example, a surface spacing d1 indicates a distance on the optical axis from the surface indicated by the surface number s1 to the surface indicated by the surface number s2. The surface spacing d25 indicates a distance on the optical axis from the surface indicated by the surface number s25 to the tube lens, and is 115.4934 mm

The values D2, D9 and D13 of the surface spacings d2, d9 and d13 in the first state illustrated in FIG. 1 in which the immersion liquid (immersion liquid A) having ND2=1.49306 and νD2=52.67 is used and in the second state illustrated in FIG. 2 in which the immersion liquid (immersion liquid B) having ND2=1.40420 and νD2=52.02 is used are as follows. Note that ND2 and νD2 are the values of the refraction index and Abbe number of the immersion liquid. The refractive index ratio (minimum/maximum) of these immersion liquids is 0.940, and the Abbe number ratio (minimum/maximum) is 0.988. In this example, the refractive indices of the immersion liquids differ by 5% or more.

| | First State | Second State |
|---|---|---|
| D2 | 1.050 | 1.005 |
| D9 | 0.1490 | 0.4277 |
| D13 | 0.9183 | 0.6396 |

The objective 1 satisfies the conditional expressions (1) to (5) as illustrated below.

first state: NA×WD=1.103 mm (1)

second state: NA×WD=1.055 mm (1)

first state: 1/|(iνd1−iνd2)×WD|=1.465 mm⁻¹ (2)

second state: 1/|(iνd1−iνd2)×WD|=1.531 mm⁻¹ (2)

(νdG1−νdG2)/R1=−15.331 mm⁻¹ (3)

first state: |(TANF−TANC)/TANd|=0.0075 (4)

second state: |(TANF−TANC)/TANd|=0.0074 (4)

(νdZ1−νdZ2)/FZ1=1.729 mm⁻¹ (5)

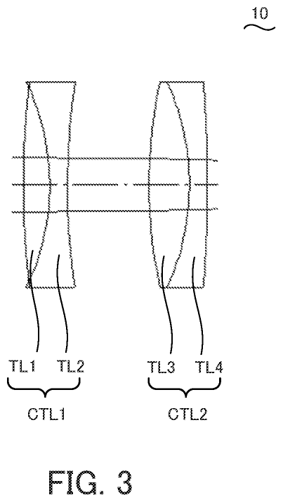

FIG. 3 is a cross-sectional view of the tube lens 10 used in combination with the objective 1. The tube lens 10 is a microscope tube lens that forms an enlarged image of an object in combination with an infinity-corrected objective. The tube lens 10 is formed of, in order from the object side, a cemented lens CTL1 and a cemented lens CTL2. The cemented lens CTL1 is formed of a lens TL1 which is a biconvex lens and a lens TL2 which is a biconcave lens. The cemented lens CTL2 is formed of a lens TL3 which is a biconvex lens and a lens TL4 which is a meniscus having a concave surface facing the object side. Note that the focal length ft of the tube lens 10 is 180 mm

Lens data of the tube lens 10 is as follows.

Tube Lens 10

| s | r | d | nd | νd |
|---|---|---|---|---|
| 1 | 214.478 | 5.7 | 1.60300 | 65.44 |
| 2 | −52.260 | 3.85 | 1.51633 | 64.14 |
| 3 | 152.781 | 17.76 | | |
| 4 | 101.004 | 8.9 | 1.48749 | 70.23 |
| 5 | −54.003 | 3.85 | 1.61340 | 44.27 |
| 6 | −289.639 | | | |

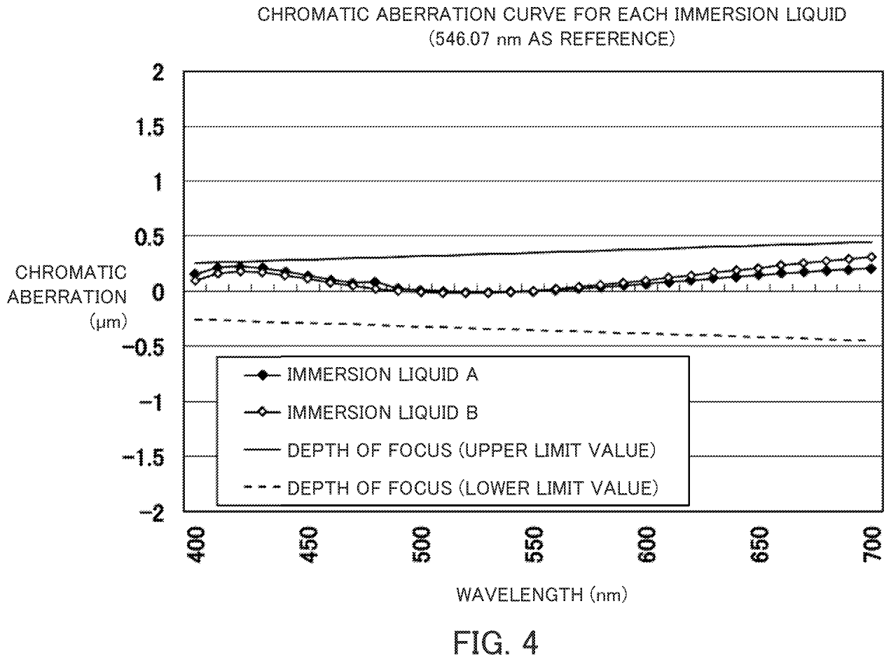

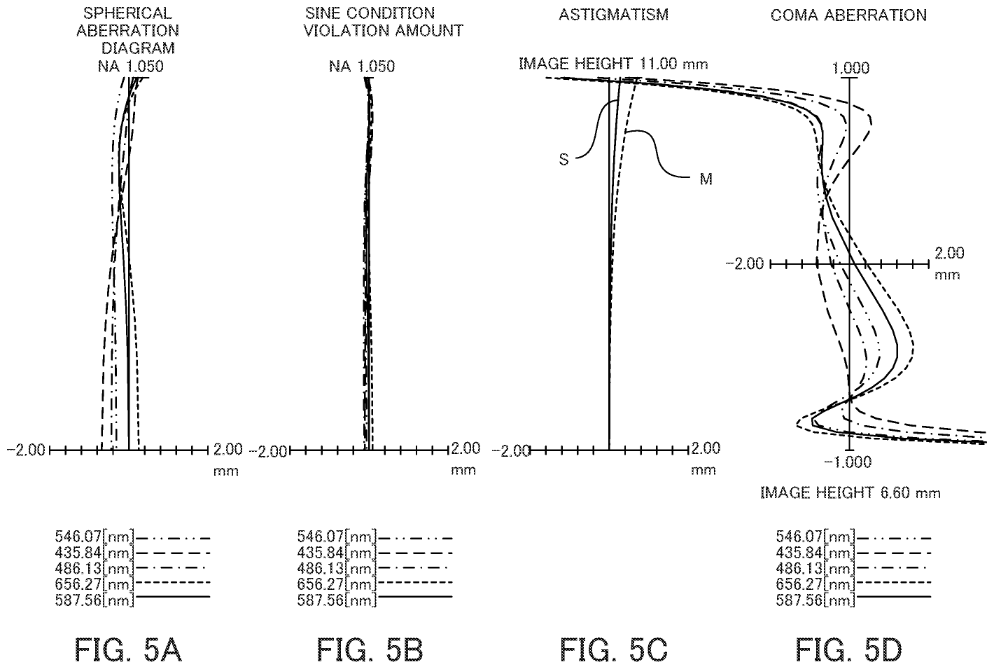

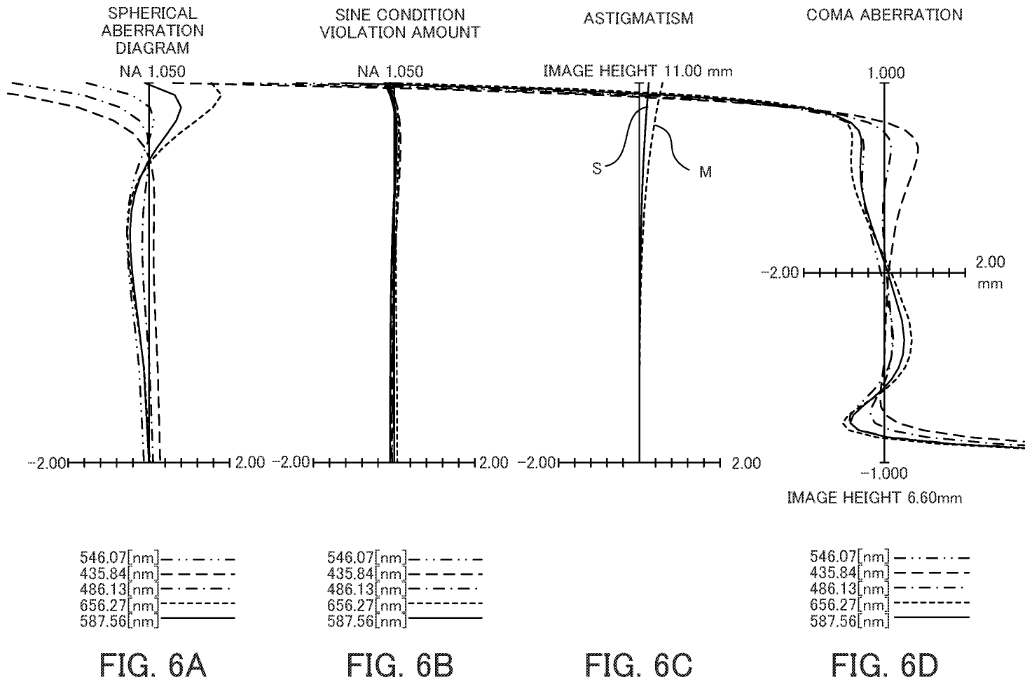

FIG. 4 is a graph illustrating the amount of chromatic aberration of an optical system formed of the objective 1 and the tube lens 10. FIGS. 5A to 5D and FIGS. 6A to 6D are aberration diagrams of the optical system formed of the objective 1 and the tube lens 10, and illustrate aberrations on the image plane formed by the objective 1 and the tube lens 10 in the first state and the second state, respectively. FIGS. 5A and 6A are spherical aberration diagrams, FIGS. 5B and 6B are diagrams illustrating sine condition violation amounts, FIGS. 5C and 6C are astigmatism diagrams, and FIGS. 5D and 6D are coma aberration diagrams. Note that in the figure, “M” indicates a meridional component and “S” indicates a sagittal component.

As illustrated in FIG. 4, in the objective 1, the chromatic aberration is within depth of focus over a wide wavelength range. As illustrated in FIGS. 5A to 5D and FIGS. 6A to 6D, in the present embodiment, each aberration is satisfactorily corrected.

### Second Embodiment

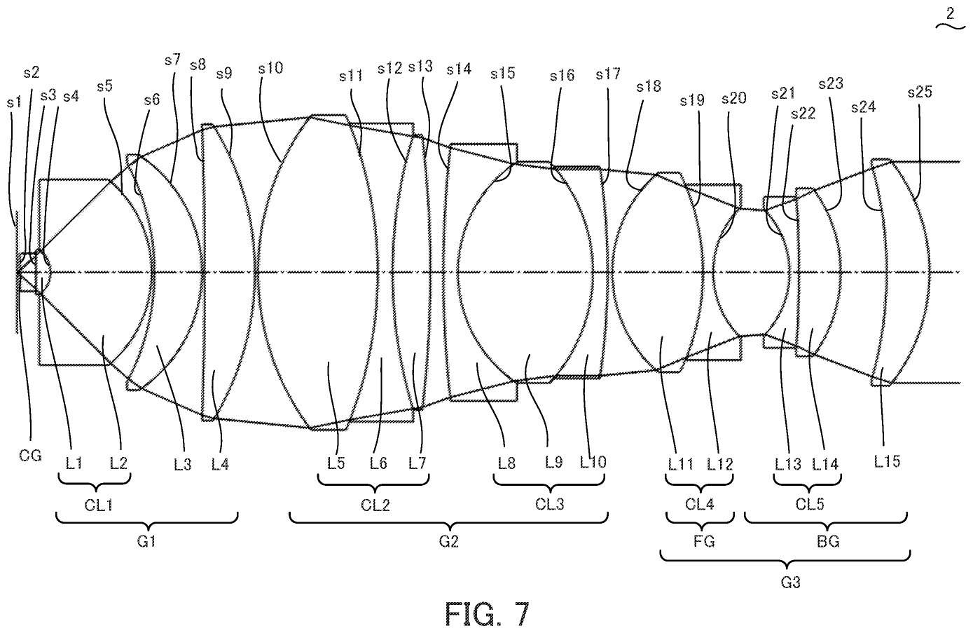

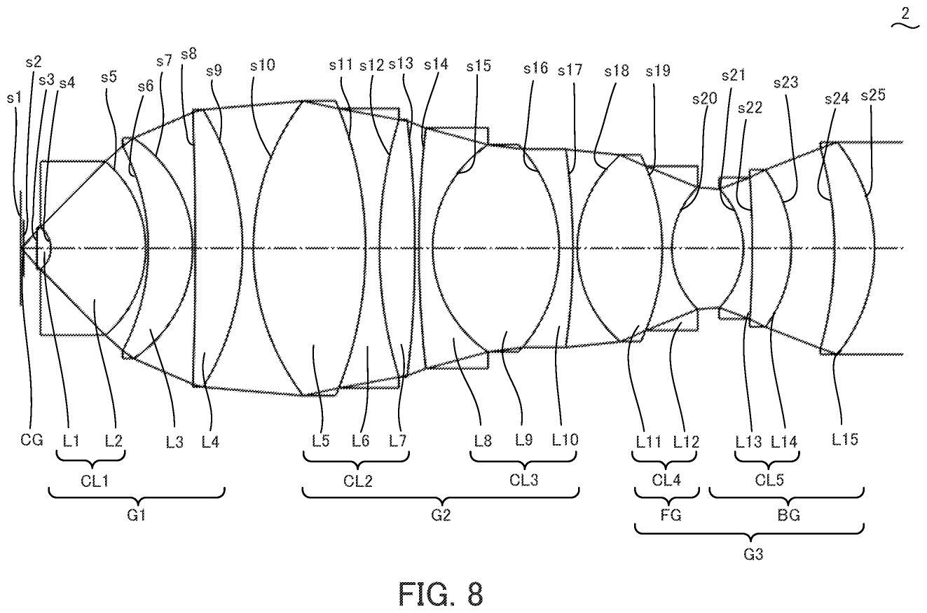

FIGS. 7 and 8 are cross-sectional views of an objective 2 according to the present embodiment. FIGS. 7 and 8 illustrate states in which the positions of the moving groups in the objective 2 are different from each other. In the present embodiment, the states illustrated in FIGS. 7 and 8 are referred to as a first state and a second state, respectively.

The objective 2 is formed of, in order from the object side, a first lens group G1 having a positive refractive power, a second lens group G2 having a positive refractive power, and a third lens group G3 having a negative refractive power. Note that the objective 2 is a liquid immersion objective for microscope.

The first lens group G1 includes, in order from the object side, a cemented lens CL1, a lens L3 which is a meniscus lens having a concave surface facing the object side, and a lens L4 which is a meniscus lens having a concave surface facing the object side. The cemented lens CL1 is a two-piece cemented lens and is formed of, in order from the object side, a lens L1 which is a plano-convex lens having a flat surface facing the object side and a lens L2 which is a meniscus lens having a concave surface facing the object side.

The second lens group G2 converts a divergent pencil of light from the first lens group G1 into a convergent pencil of light. The second lens group G2 includes, in order from the object side, a cemented lens CL2 which is a three-piece cemented lens and a cemented lens CL3 which is a three-piece cemented lens. The cemented lens CL2 is a moving group, is a positive-negative-positive three-piece cemented lens, and is formed of, in order from the object side, a lens L5 which is a biconvex lens, a lens L6 which is a biconcave lens, and a lens L7 which is a biconvex lens. The cemented lens CL3 is formed of, in order from the object side, a lens L8 which is a meniscus lens having a concave surface facing the image side, a lens L9 which is a biconvex lens, and a lens L10 which is a meniscus lens having a concave surface facing the object side.

The third lens group G3 is formed of a front group FG (cemented lens CL4) and a back group BG (cemented lens CL5 and lens L15) having concave surfaces facing each other. The third lens group G3 includes, in order from the object side, a cemented lens CL4, a cemented lens CL5, and a lens L15 which is a meniscus lens having a concave surface facing the object side. The cemented lens CL4 is formed of, in order from the object side, a lens L11 which is a biconvex lens and a lens L12 which is a biconcave lens. The cemented lens CL5 is formed of, in order from the object side, a lens L13 which is a meniscus lens having a concave surface facing the object side and a lens L14 which is a meniscus lens having a concave surface facing the object side.

Various data of the objective 2 are as follows.

β≈30, f=6.0029 mm (first state), f=6.1475 mm (second state), f1=9.4661 mm, f2=36.8352 mm, f3=−81.6475 mm, NA=1.00, WD=0.850 mm (first state), WD=0.781 mm (second state), iνd1=52.67, iνd2=55.38, νdG1=67.720, νdG2=40.760, R1=−1.5350 mm, νdZ1=71.30, νdZ2=42.41, FZ1=23.402 mm

(first state) TANF=0.3543, TANC=0.3492, TANd=0.3507

(second state) TANF=0.3749, TANC=0.3695, TANd=0.3711

Lens data of the objective 2 is as follows.

Objective Lens 2

| s | r | d | nd | νd |
|---|---|---|---|---|
| 1 | INF | 0.1700 | 1.52397 | 54.41 |
| 2 | INF | D2 | NE2 | νD2 |
| 3 | INF | 0.8000 | 1.45847 | 67.72 |
| 4 | −1.5350 | 5.4941 | 1.88300 | 40.76 |
| 5 | −6.5836 | 0.1500 | | |
| 6 | −12.5625 | 2.5789 | 1.59240 | 68.30 |
| 7 | −7.6530 | 0.1500 | | |
| 8 | −209.1907 | 2.7297 | 1.59240 | 68.30 |
| 9 | −15.2534 | D9 | | |
| 10 | 14.0480 | 6.5069 | 1.56907 | 71.30 |
| 11 | −21.8947 | 0.8000 | 1.63775 | 42.41 |
| 12 | 25.0690 | 2.0677 | 1.56907 | 71.30 |
| 13 | −61.7685 | D13 | | |
| 14 | 59.9028 | 0.8000 | 1.63775 | 42.41 |
| 15 | 7.2185 | 7.3374 | 1.43875 | 94.66 |
| 16 | −8.7943 | 0.8000 | 1.63775 | 42.41 |
| 17 | −39.7134 | 0.2500 | | |
| 18 | 7.1180 | 4.9261 | 1.59240 | 68.30 |
| 19 | −12.2879 | 0.5537 | 1.63775 | 42.41 |
| 20 | 4.9117 | 4.1500 | | |
| 21 | −4.9235 | 0.5123 | 1.88300 | 40.76 |
| 22 | −57.5518 | 2.2653 | 1.43875 | 94.66 |
| 23 | −7.6624 | 2.4988 | | |
| 24 | −21.0693 | 2.3246 | 1.85025 | 30.05 |
| 25 | −9.8175 | 120.0000 | | |

Surfaces indicated by surface numbers s1 and s2 are an object-side surface of a cover glass CG and an image-side surface of the cover glass CG, respectively. Surfaces indicated by surface numbers s3 and s25 are a lens surface closest to the object side and a lens surface closest to the image side of the objective 2, respectively.

The values D2, D9 and D13 of the surface spacings d2, d9 and d13 in the first state illustrated in FIG. 7 in which the immersion liquid (immersion liquid A) having ND2=1.49306 and νD2=52.67 is used and in the second state illustrated in FIG. 8 in which the immersion liquid (immersion liquid C) having ND2=1.33276 and νD2=55.38 is used are as follows. The refractive index ratio (minimum/maximum) of these immersion liquids is 0.893, and the Abbe number ratio (minimum/maximum) is 0.951. In this example, the refractive indices of the immersion liquids differ by 10% or more and the Abbe numbers differ by nearly 5%.

| | First State | Second State |
|---|---|---|
| D2 | 0.8500 | 0.7805 |
| D9 | 0.1628 | 0.6302 |
| D13 | 0.6833 | 0.2159 |

The objective 2 satisfies the conditional expressions (1) to (5) as illustrated below.

first state: NA×WD=0.850 mm (1)

second state: NA×WD=0.781 mm (1)

first state: 1/|(iνd1−iνd2)×WD|=0.434 mm⁻¹ (2)

second state: 1/|(iνd1−iνd2)×WD|=0.473 mm⁻¹ (2)

(νdG1−νdG2)/R1=−17.561 mm⁻¹ (3)

first state: |(TANF−TANC)/TANd|=0.0145 (4)

second state: |(TANF−TANC)/TANd|=0.0144 (4)

(νdZ1−νdZ2)/FZ1=1.235 mm⁻¹ (5)

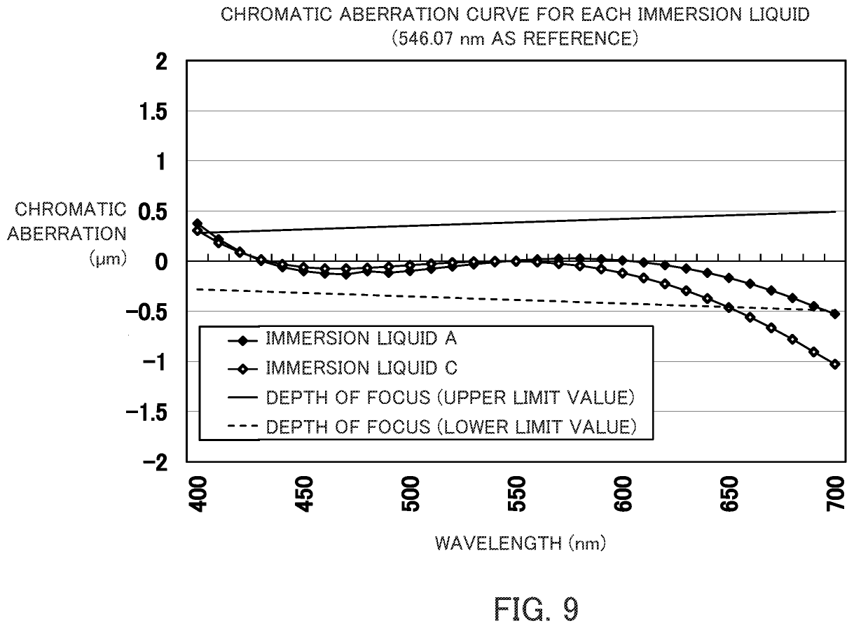

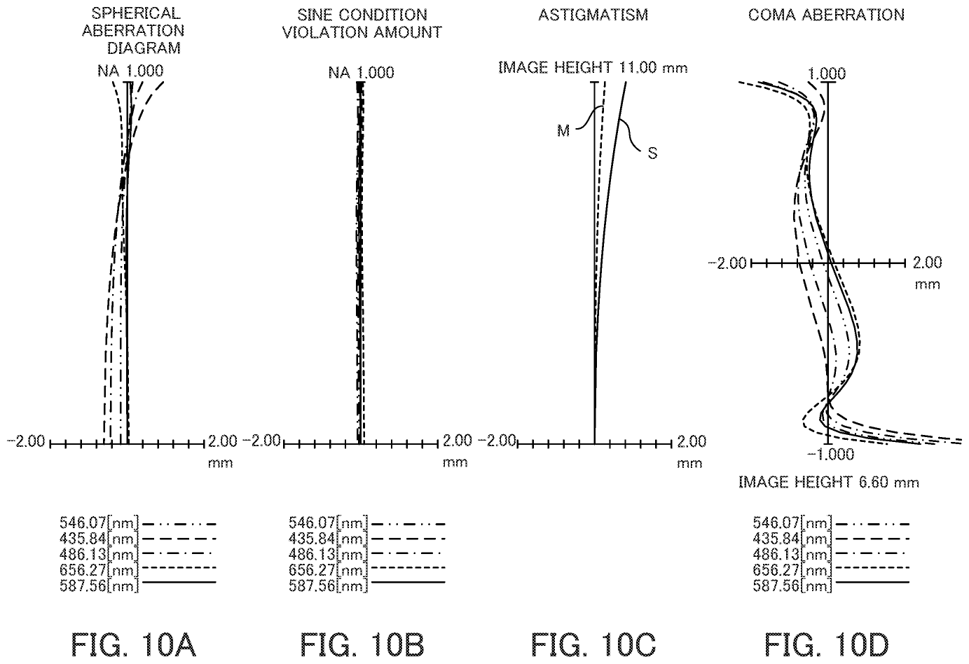

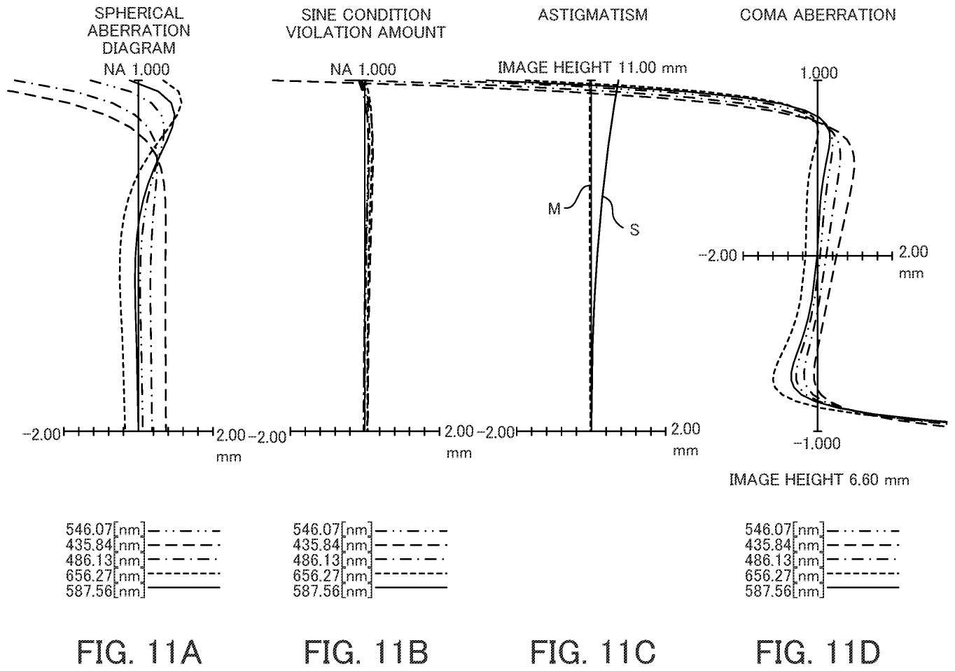

FIG. 9 is a graph illustrating the amount of chromatic aberration of an optical system formed of the objective 2 and the tube lens 10. FIGS. 10A to 10D and FIGS. 11A to 11D are aberration diagrams of the optical system formed of the objective 2 and the tube lens 10, and illustrate aberrations on the image plane formed by the objective 2 and the tube lens 10 in the first state and the second state, respectively. FIGS. 10A and 11A are spherical aberration diagrams, FIGS. 10B and 11B are diagrams illustrating sine condition violation amounts, FIGS. 10C and 11C are astigmatism diagrams, and FIGS. 10D and 11D are coma aberration diagrams.

As illustrated in FIG. 9, in the objective 2, the chromatic aberration is within depth of focus over a wide wavelength range. As illustrated in FIGS. 10A to 10D and FIGS. 11A to 11D, in the present embodiment, each aberration is satisfactorily corrected.

### Third Embodiment

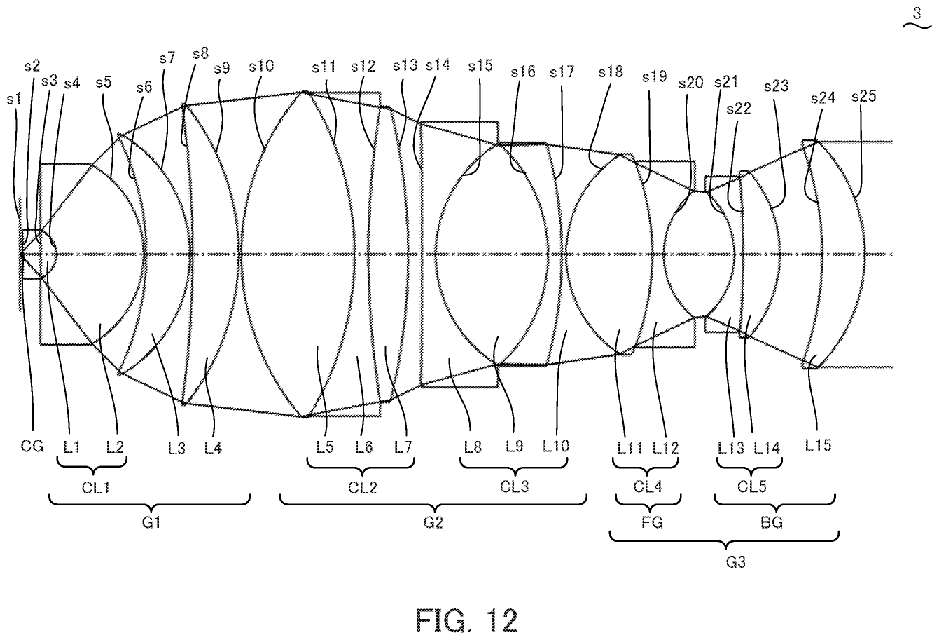

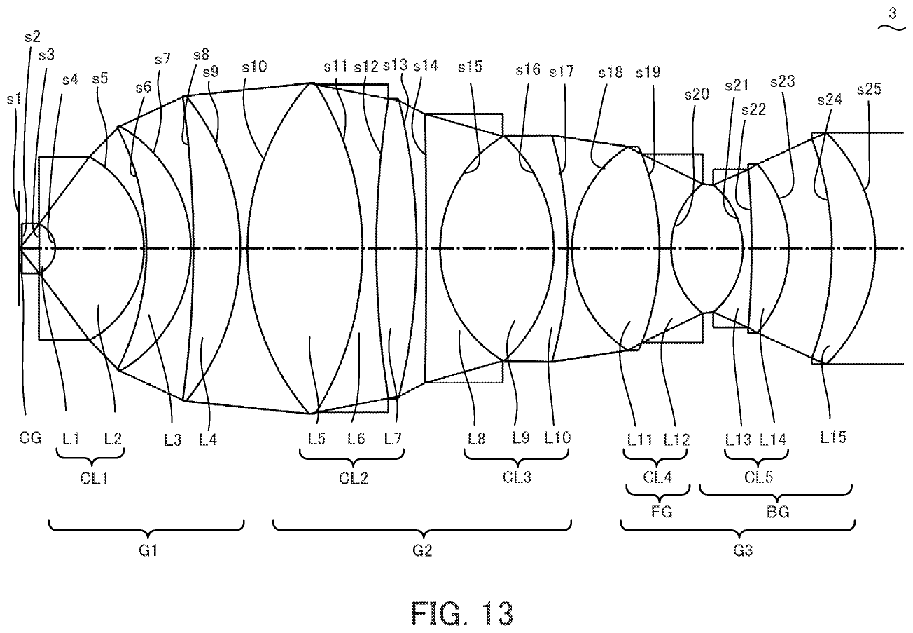

FIGS. 12 and 13 are cross-sectional views of an objective 3 according to the present embodiment. FIGS. 12 and 13 illustrate states in which the positions of the moving groups in the objective 3 are different from each other. In the present embodiment, the states illustrated in FIGS. 12 and 13 are referred to as a first state and a second state, respectively.

The objective 3 is formed of, in order from the object side, a first lens group G1 having a positive refractive power, a second lens group G2 having a positive refractive power, and a third lens group G3 having a negative refractive power. Note that the objective 3 is a liquid immersion objective for microscope.

The first lens group G1 includes, in order from the object side, a cemented lens CL1, a lens L3 which is a meniscus lens having a concave surface facing the object side, and a lens L4 which is a meniscus lens having a concave surface facing the object side. The cemented lens CL1 is a two-piece cemented lens and is formed of, in order from the object side, a lens L1 which is a plano-convex lens having a flat surface facing the object side and a lens L2 which is a meniscus lens having a concave surface facing the object side.

The second lens group G2 converts a divergent pencil of light from the first lens group G1 into a convergent pencil of light. The second lens group G2 includes, in order from the object side, a cemented lens CL2 which is a three-piece cemented lens and a cemented lens CL3 which is a three-piece cemented lens. The cemented lens CL2 is a moving group, is a positive-negative-positive three-piece cemented lens, and is formed of, in order from the object side, a lens L5 which is a biconvex lens, a lens L6 which is a biconcave lens, and a lens L7 which is a biconvex lens. The cemented lens CL3 is formed of, in order from the object side, a lens L8 which is a biconcave lens, a lens L9 which is a biconvex lens, and a lens L10 which is a meniscus lens having a concave surface facing the object side.

The third lens group G3 is formed of a front group FG (cemented lens CL4) and a back group BG (cemented lens CL5 and lens L15) having concave surfaces facing each other. The third lens group G3 includes, in order from the object side, a cemented lens CL4, a cemented lens CL5, and a lens L15 which is a meniscus lens having a concave surface facing the object side. The cemented lens CL4 is formed of, in order from the object side, a lens L11 which is a biconvex lens and a lens L12 which is a biconcave lens. The cemented lens CL5 is formed of, in order from the object side, a lens L13 which is a meniscus lens having a concave surface facing the object side and a lens L14 which is a meniscus lens having a concave surface facing the object side.

Various data of the objective 3 are as follows.

β≈30, f=6.0032 mm (first state), f=6.0944 mm (second state), f1=9.4502 mm, f2=34.1154 mm, f3=−61.4204 mm, NA=1.10, WD=1.050 mm (first state), WD=1.006 mm (second state), iνd1=52.02, iνd2=52.67, νdG1=67.720, νdG2=40.760, R1=−1.5450 mm, νdZ1=71.30, νdZ2=42.41, FZ1=21.333 mm

(first state) TANF=0.4977, TANC=0.4947, TANd=0.4956

(second state) TANF=0.5164, TANC=0.5134, TANd=0.5143

Lens data of the objective 3 is as follows.

Objective Lens 3

| s | r | d | nd | νd |
|---|---|---|---|---|
| 1 | INF | 0.1700 | 1.52397 | 54.41 |
| 2 | INF | D2 | NE2 | νD2 |
| 3 | INF | 0.9200 | 1.45847 | 67.72 |
| 4 | −1.5450 | 5.1290 | 1.88300 | 40.76 |
| 5 | −6.0278 | 0.1500 | | |
| 6 | −15.4024 | 2.5652 | 1.56907 | 71.30 |
| 7 | −8.1461 | 0.1500 | | |
| 8 | −62.2824 | 2.7055 | 1.56907 | 71.30 |
| 9 | −13.9511 | D9 | | |
| 10 | 14.5760 | 6.6491 | 1.56907 | 71.30 |
| 11 | −18.0428 | 0.8000 | 1.63775 | 42.41 |
| 12 | 53.7477 | 2.3414 | 1.56907 | 71.30 |
| 13 | −36.1182 | D13 | | |
| 14 | −402.5974 | 0.8000 | 1.63775 | 42.41 |
| 15 | 7.5997 | 6.5942 | 1.43875 | 94.66 |
| 16 | −8.7656 | 0.8000 | 1.63775 | 42.41 |
| 17 | −24.0319 | 0.2500 | | |
| 18 | 6.9910 | 5.0586 | 1.56907 | 71.30 |
| 19 | −14.9105 | 0.6695 | 1.63775 | 42.41 |
| 20 | 4.7526 | 4.1500 | | |
| 21 | −4.8267 | 0.5118 | 1.88300 | 40.76 |
| 22 | −52.9845 | 2.1486 | 1.43875 | 94.66 |
| 23 | −7.4312 | 2.4866 | | |
| 24 | −17.8978 | 2.5000 | 1.85025 | 30.05 |
| 25 | −9.3407 | 120.0000 | | |

Surfaces indicated by surface numbers s1 and s2 are an object-side surface of a cover glass CG and an image-side surface of the cover glass CG, respectively. Surfaces indicated by surface numbers s3 and s25 are a lens surface closest to the object side and a lens surface closest to the image side of the objective 3, respectively.

The values D2, D9 and D13 of the surface spacings d2, d9 and d13 in the first state illustrated in FIG. 12 in which the immersion liquid (immersion liquid A) having ND2=1.49306 and νD2=52.67 is used and in the second state illustrated in FIG. 13 in which the immersion liquid (immersion liquid B) having ND2=1.40420 and νD2=52.02 is used are as follows. The refractive index ratio (minimum/maximum) of these immersion liquids is 0.940, and the Abbe number ratio (minimum/maximum) is 0.988. In this example, the refractive indices of the immersion liquids differ by 5% or more.

| | First State | Second State |
|---|---|---|
| D2 | 1.0500 | 1.0059 |
| D9 | 0.1497 | 0.4142 |
| D13 | 0.8126 | 0.5481 |

The objective 3 satisfies the conditional expressions (1) to (5) as illustrated below.

first state: NA×WD=1.155 mm (1)

second state: NA×WD=1.106 mm (1)

first state: 1/|(iνd1−iνd2)×WD|=1.465 mm⁻¹ (2)

second state: 1/|(iνd1−iνd2)×WD|=1.529 mm⁻¹ (2)

(νdG1−νdG2)/R1=−17.450 mm⁻¹ (3)

first state: |(TANF−TANC)/TANd|=0.0061 (4)

second state: |(TANF−TANC)/TANd|=0.0057 (4)

(νdZ1−νdZ2)/FZ1=1.354 mm⁻¹ (5)

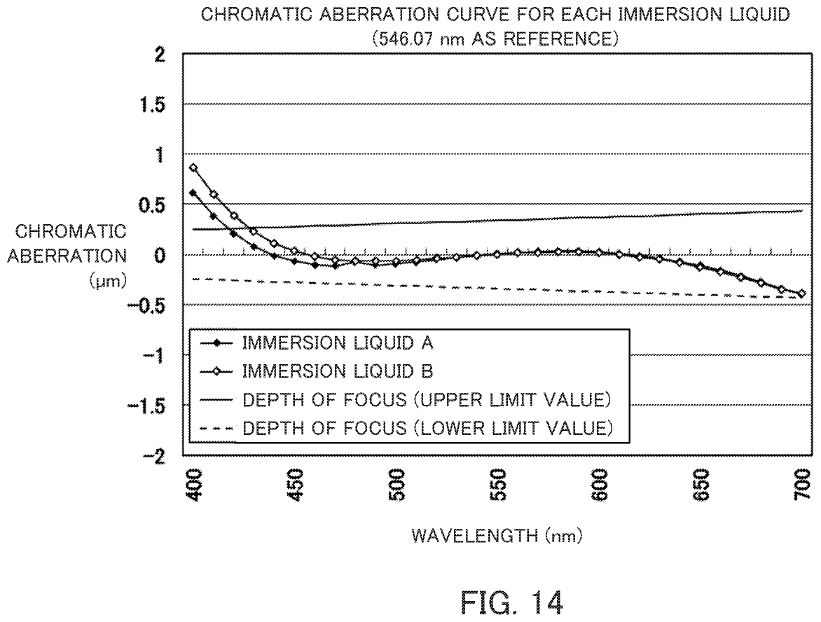

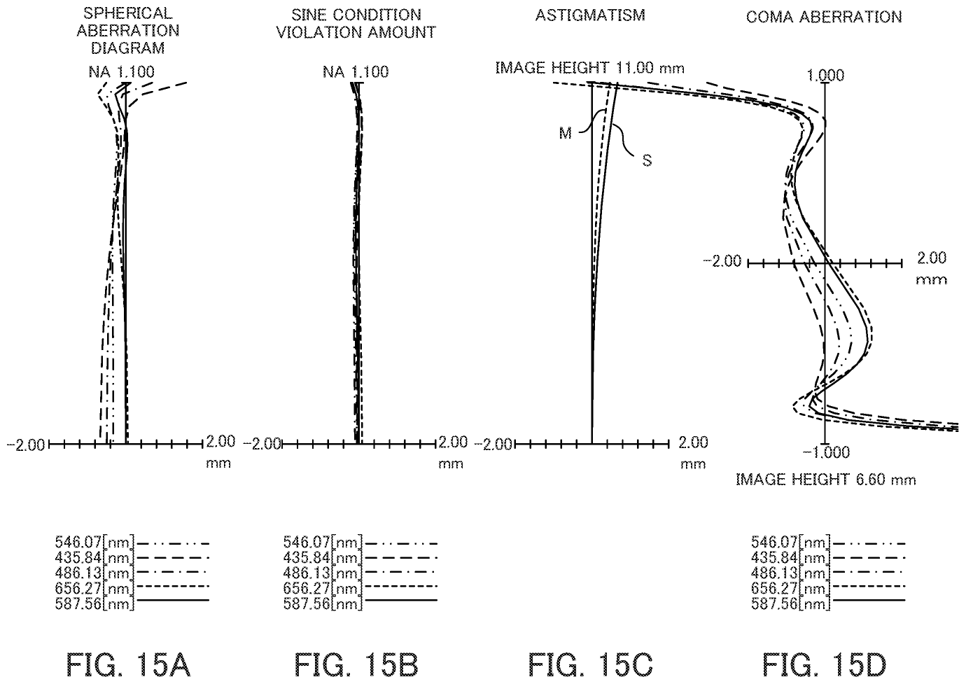

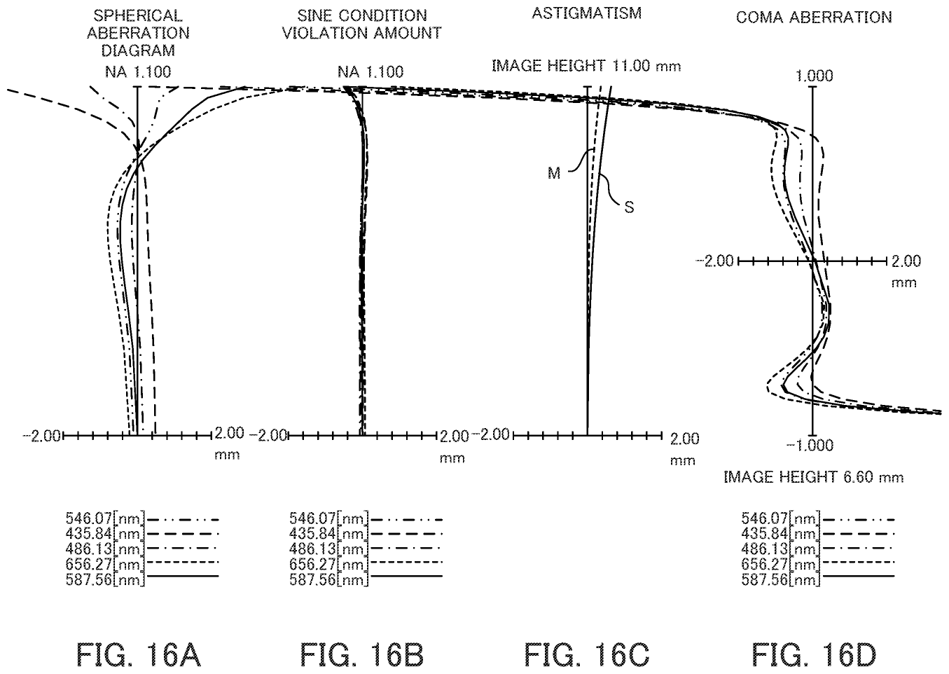

FIG. 14 is a graph illustrating the amount of chromatic aberration of an optical system formed of the objective 3 and the tube lens 10. FIGS. 15A to 15D and FIGS. 16A to 16D are aberration diagrams of the optical system formed of the objective 3 and the tube lens 10, and illustrate aberrations on the image plane formed by the objective 3 and the tube lens 10 in the first state and the second state, respectively. FIGS. 15A and 16A are spherical aberration diagrams, FIGS. 15B and 16B are diagrams illustrating sine condition violation amounts, FIGS. 15C and 16C are astigmatism diagrams, and FIGS. 15D and 16D are coma aberration diagrams.

As illustrated in FIG. 14, in the objective 3, the chromatic aberration is within depth of focus over a wide wavelength range. As illustrated in FIGS. 15A to 15D and FIGS. 16A to 16D, in the present embodiment, each aberration is satisfactorily corrected.

### Fourth Embodiment

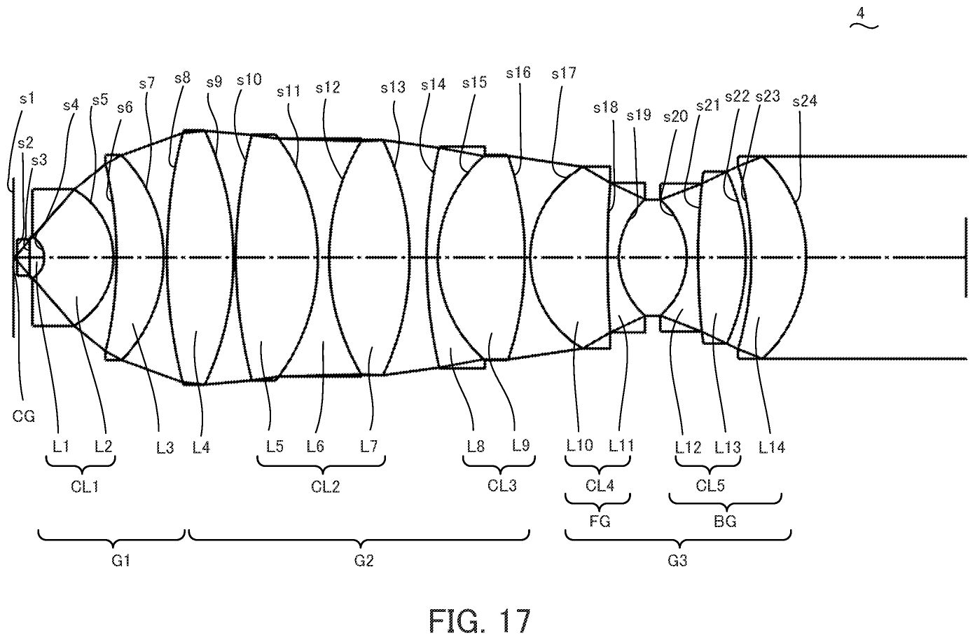

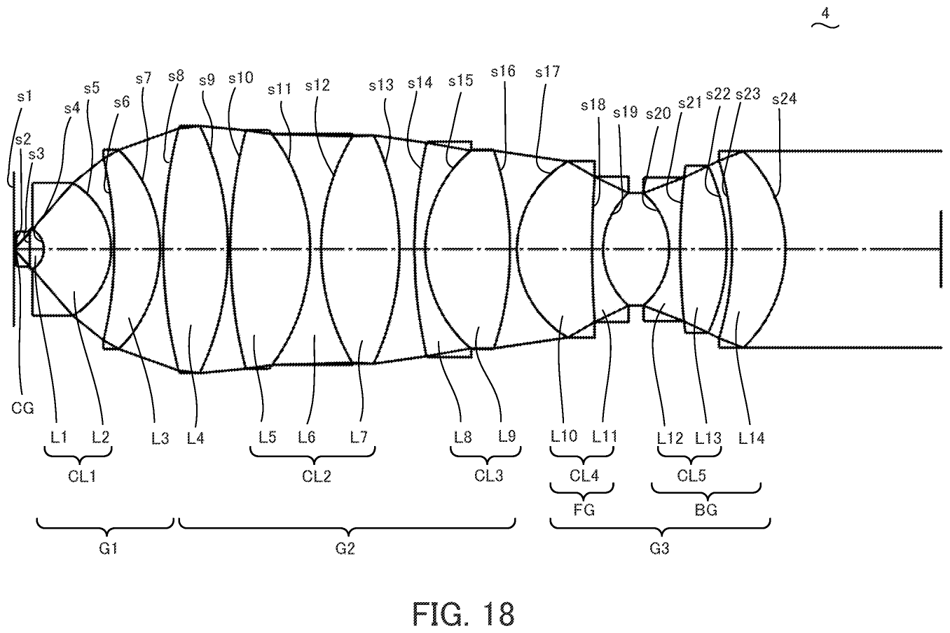

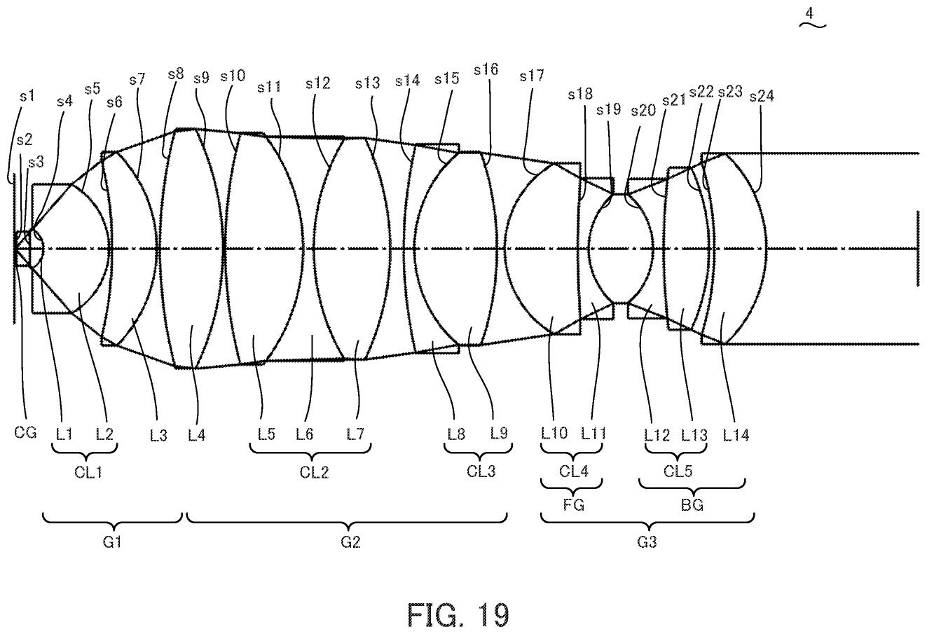

FIGS. 17 to 20 are cross-sectional views of an objective 4 according to the present embodiment. FIGS. 17 to 20 illustrate states in which the positions of the moving groups in the objective 4 are different from each other. In the present embodiment, the states illustrated in FIGS. 17, 18, 19 and 20 are referred to as a first state, a second state, a third state, and a fourth state, respectively.

The objective 4 is formed of, in order from the object side, a first lens group G1 having a positive refractive power, a second lens group G2 having a positive refractive power, and a third lens group G3 having a negative refractive power. Note that the objective 4 is a liquid immersion objective for microscope.

The first lens group G1 includes, in order from the object side, a cemented lens CL1, and a lens L3 which is a meniscus lens having a concave surface facing the object side. The cemented lens CL1 is a two-piece cemented lens and is formed of, in order from the object side, a lens L1 which is a plano-convex lens having a flat surface facing the object side and a lens L2 which is a meniscus lens having a concave surface facing the object side.

The second lens group G2 converts a divergent pencil of light from the first lens group G1 into a convergent pencil of light. The second lens group G2 includes, in order from the object side, a lens L4 which is a biconvex lens, a cemented lens CL2 which is a three-piece cemented lens, and a cemented lens CL3 which is a two-piece cemented lens. The cemented lens CL2 is a positive-negative-positive three-piece cemented lens, and is formed of, in order from the object side, a lens L5 which is a biconvex lens, a lens L6 which is a biconcave lens, and a lens L7 which is a biconvex lens. The cemented lens CL3 is a moving group and is formed of, in order from the object side, a lens L8 which is a meniscus lens having a concave surface facing the image side and a lens L9 which is a biconvex lens.

The third lens group G3 is formed of a front group FG (cemented lens CL4) and a back group BG (cemented lens CL5 and lens L14) having concave surfaces facing each other. The third lens group G3 includes, in order from the object side, a cemented lens CL4, a cemented lens CL5, and a lens L14 which is a meniscus lens having a concave surface facing the object side. The cemented lens CL4 is formed of, in order from the object side, a lens L10 which is a meniscus lens having a concave surface facing the image side and a lens L11 which is a meniscus lens having a concave surface facing the image side. The cemented lens CL5 is formed of, in order from the object side, a lens L12 which is a biconcave lens and a lens L13 which is a biconvex lens.

Various data of the objective 4 are as follows.

β≈30, f=6.0079 mm (first state), f=6.0028 mm (second state), f=5.9993 (third state), f=5.9780 mm (fourth state), f1=11.9111 mm, f2=17.7457 mm, f3=−40.3094 mm, NA=1.05, WD=0.797 mm (first state), WD=0.850 mm (second state), WD=0.885 (third state), WD=0.861 mm (fourth state), iνd1=52.02, iνd2=52.40, νdG1=67.720, νdG2=40.760, R1=−1.5220 mm, νdZ1=94.66, νdZ2=52.64, FZ1=85.061 mm

(first state) TANF=0.1447, TANC=0.1468, TANd=0.1462

(second state) TANF=0.1446, TANC=0.1467, TANd=0.1462

(third state) TANF=0.1446, TANC=0.1466, TANd=0.1461

(fourth state) TANF=0.1447, TANC=0.1465, TANd=0.1460

Lens data of the objective 4 is as follows.

Objective Lens 4

| s | r | d | nd | νd |
|---|---|---|---|---|
| 1 | INF | D1 | 1.52397 | 54.41 |
| 2 | INF | D2 | NE2 | νD2 |
| 3 | INF | 0.9000 | 1.45847 | 67.72 |
| 4 | −1.5220 | 4.3202 | 1.88300 | 40.76 |
| 5 | −4.9146 | 0.2000 | | |
| 6 | −25.1275 | 2.9440 | 1.56907 | 71.30 |
| 7 | −9.0618 | 0.2000 | | |
| 8 | 31.1362 | 4.1640 | 1.56907 | 71.30 |
| 9 | −18.3264 | 0.1500 | | |
| 10 | 29.7812 | 5.1322 | 1.43875 | 94.66 |
| 11 | −12.4198 | 0.7000 | 1.63775 | 42.41 |
| 12 | 14.1866 | 5.0382 | 1.43875 | 94.66 |
| 13 | −16.9637 | D13 | | |
| 14 | 30.2478 | 0.7000 | 1.74100 | 52.64 |
| 15 | 8.3880 | 5.4520 | 1.43875 | 94.66 |
| 16 | −19.7504 | D16 | | |
| 17 | 6.5227 | 4.8207 | 1.56907 | 71.30 |
| 18 | 64.4447 | 0.7114 | 1.88300 | 40.76 |
| 19 | 4.8201 | 4.2500 | | |
| 20 | −4.7776 | 0.7000 | 1.63775 | 42.41 |
| 21 | 44.1838 | 2.9892 | 1.43875 | 94.66 |
| 22 | −12.7548 | 0.3489 | | |
| 23 | −19.9219 | 3.4291 | 1.73800 | 32.33 |
| 24 | −8.7182 | 120.0000 | | |

Surfaces indicated by surface numbers s1 and s2 are an object-side surface of a cover glass CG and an image-side surface of the cover glass CG, respectively. Surfaces indicated by surface numbers s3 and s24 are a lens surface closest to the object side and a lens surface closest to the image side of the objective 4, respectively.

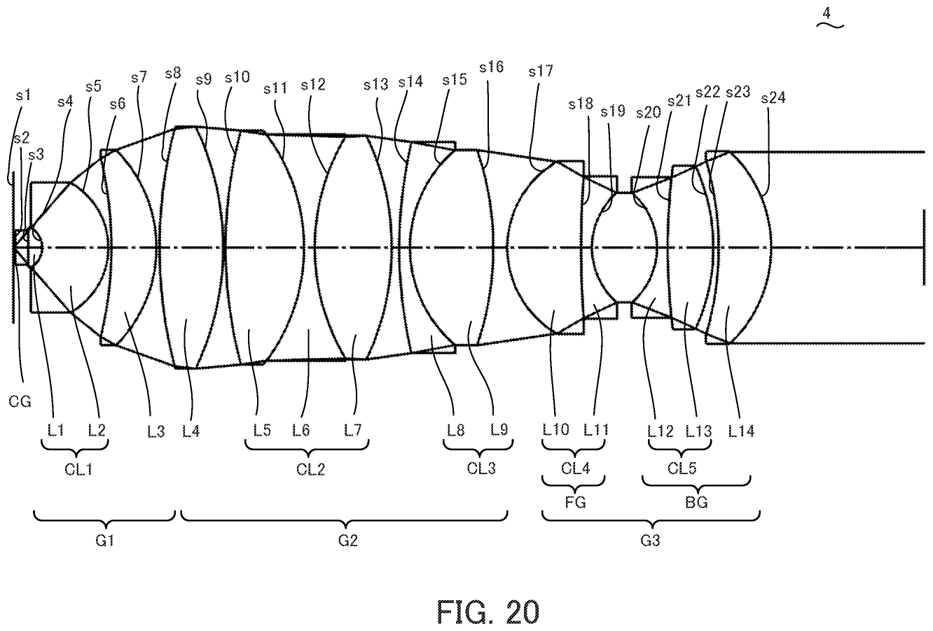

The values D1, D2, D13 and D16 of the surface spacings d1, d2, d13 and d16 in the first to third states illustrated in FIGS. 17 to 19 in which the immersion liquid (immersion liquid B) having ND2=1.40420 and νD2=52.02 is used together with the cover glass having different thicknesses, and in the fourth state illustrated in FIG. 20 in which the immersion liquid (immersion liquid D) having ND2=1.37919 and νD2=52.40 is used are as follows. Note that the surface spacing d1 is the thickness of the cover glass. The refractive index ratio (minimum/maximum) of these immersion liquids is 0.982, and the Abbe number ratio (minimum/maximum) is 0.993. In this example, the refractive indices of the immersion liquids differ by nearly 2%.

| | First State | Second State | Third State | Fourth State |
|---|---|---|---|---|
| D1 | 0.2300 | 0.1700 | 0.1300 | 0.1300 |
| D2 | 0.7968 | 0.8500 | 0.8854 | 0.8610 |
| D13 | 1.0518 | 0.9541 | 0.8867 | 0.4833 |
| D16 | 0.3428 | 0.4405 | 0.5079 | 0.9112 |

The objective 4 satisfies the conditional expressions (1) to (5) as illustrated below.

first state: NA×WD=0.837 mm (1)

second state: NA×WD=0.893 mm (1)

third state: NA×WD=0.930 mm (1)

fourth state: NA×WD=0.904 mm (1)

first state: 1/|(iνd1−iνd2)×WD|=3.303 mm⁻¹ (2)

second state: 1/|(iνd1−iνd2)×WD|=3.096 mm⁻¹ (2)

third state: 1/|(iνd1−iνd2)×WD|=2.972 mm⁻¹ (2)

fourth state: 1/|(iνd1−iνd2)×WD|=3.056 mm⁻¹ (2)

(νdG1−νdG2)/R1=−17.714 mm⁻¹ (3)

first state: |(TANF−TANC)/TANd|=0.0143 (4)

second state: |(TANF−TANC)/TANd|=0.0140 (4)

third state: |(TANF−TANC)/TANd|=0.0138 (4)

fourth state: |(TANF−TANC)/TANd|=0.0121 (4)

(νdZ1−νdZ2)/FZ1=0.494 mm⁻¹ (5)

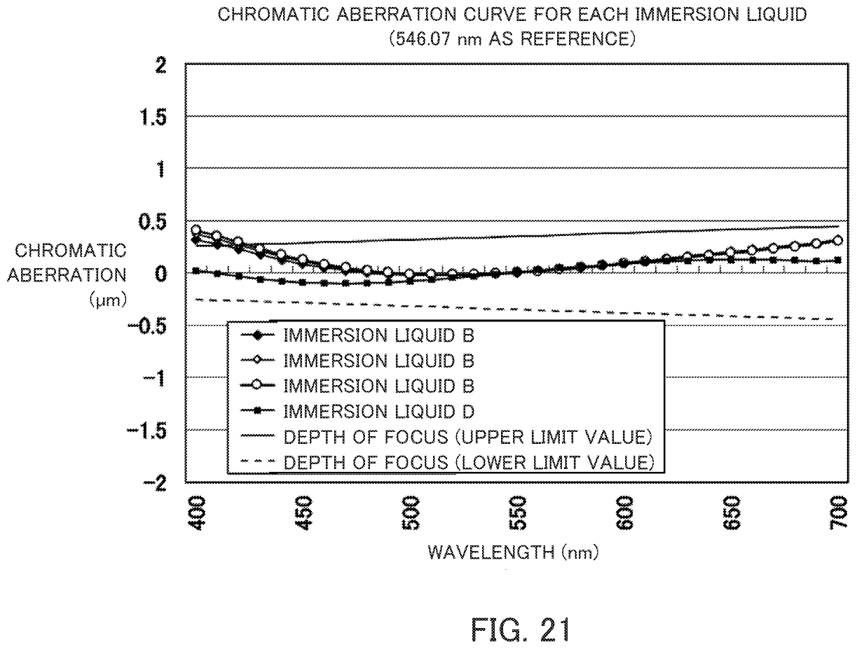

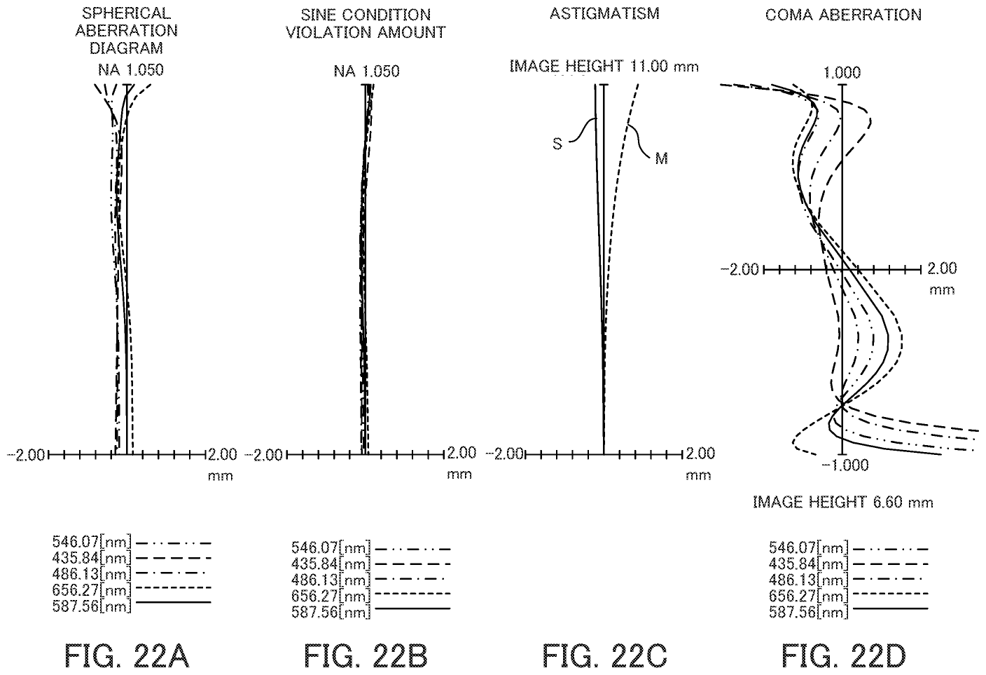

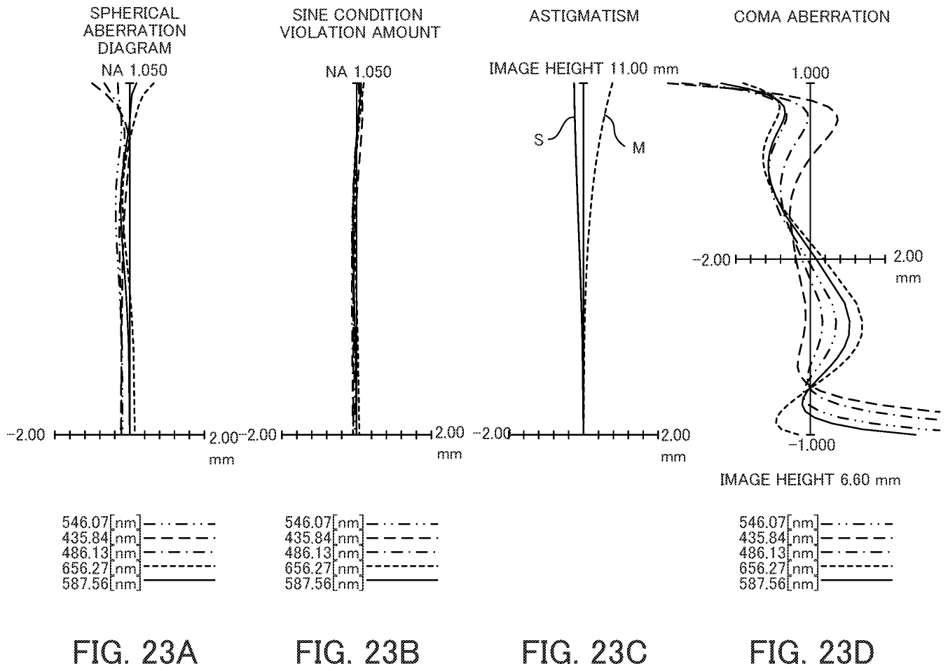

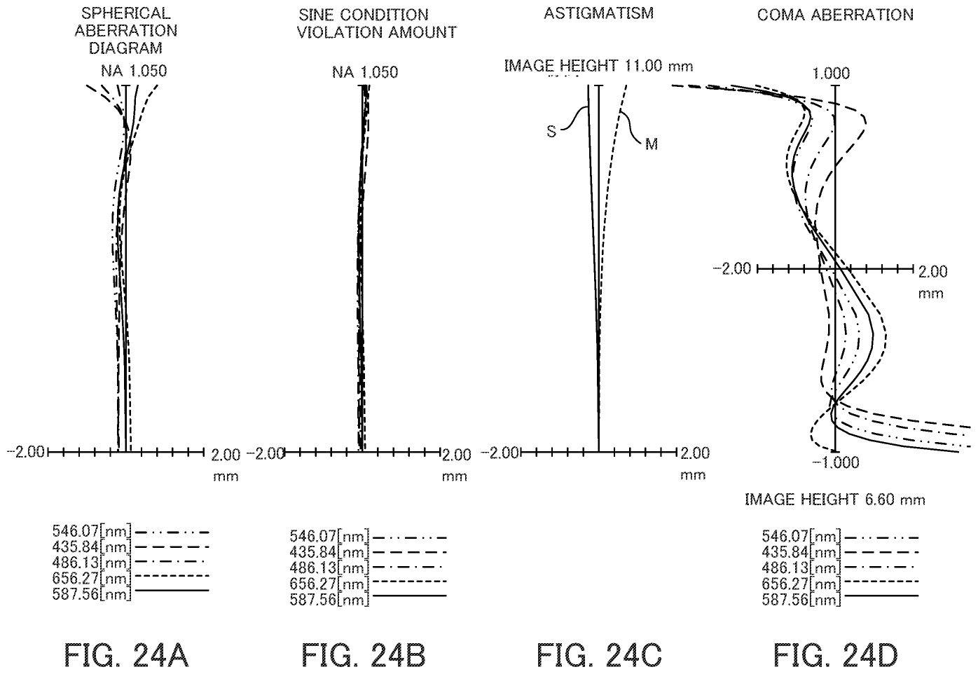

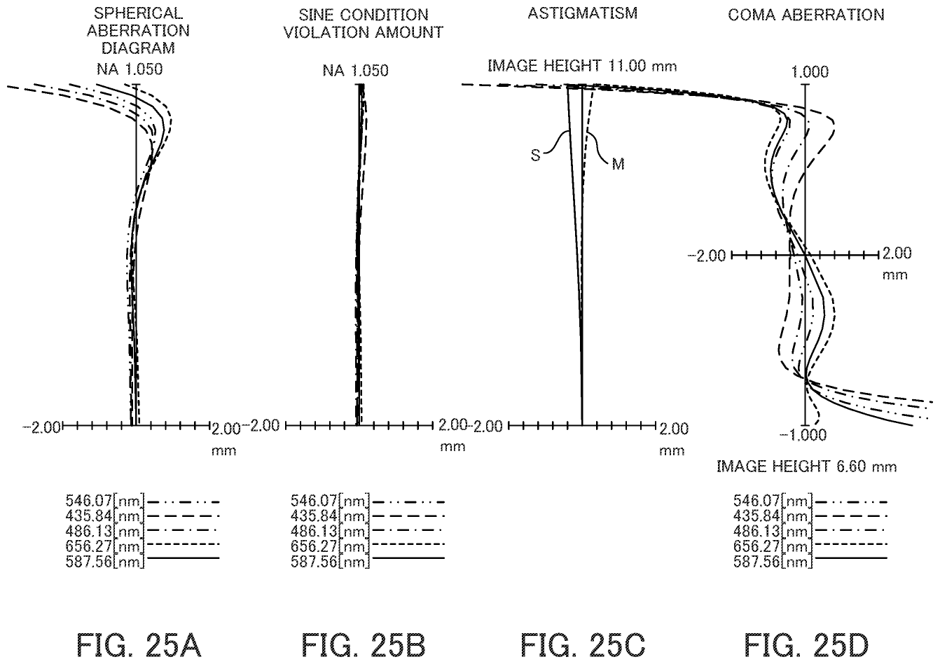

FIG. 21 is a graph illustrating the amount of chromatic aberration of an optical system formed of the objective 4 and the tube lens 10. FIGS. 22A to 22D, FIGS. 23A to 23D, FIGS. 24A to 24D, and FIGS. 25A to 25D are aberration diagrams of the optical system formed of the objective 4 and the tube lens 10, and illustrate aberrations on the image plane formed by the objective 4 and the tube lens 10 in the first state to the fourth state, respectively. FIGS. 22A, 23A, 24A and 25A are spherical aberration diagrams, FIGS. 22B, 23B, 24B and 25B are diagrams illustrating sine condition violation amounts, FIGS. 22C, 23C, 24C and 25C are astigmatism diagrams, and FIGS. 22D, 23D, 24D and 25D are coma aberration diagrams.

As illustrated in FIG. 21, in the objective 4, the chromatic aberration is within depth of focus over a wide wavelength range. As illustrated in FIGS. 22A to 22D, FIGS. 23A to 23D, FIGS. 24A to 24D, and FIGS. 25A to 25D, in the present embodiment, each aberration is satisfactorily corrected.

### Fifth Embodiment

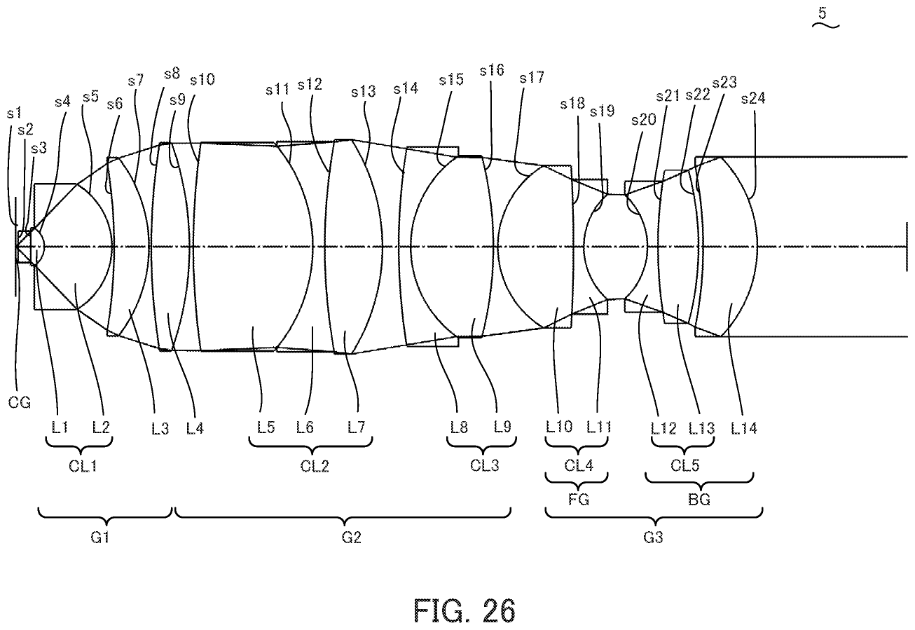

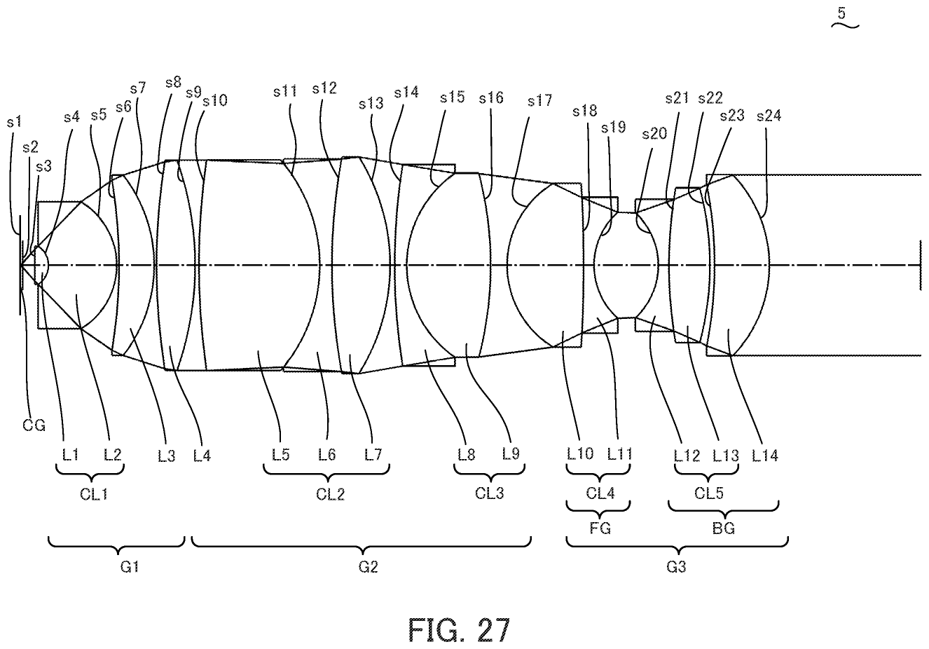

FIGS. 26 and 27 are cross-sectional views of an objective 5 according to the present embodiment. FIGS. 26 and 27 illustrate states in which the positions of the moving groups in the objective 5 are different from each other. In the present embodiment, the states illustrated in FIGS. 26 and 27 are referred to as a first state and a second state, respectively.

The objective 5 is formed of, in order from the object side, a first lens group G1 having a positive refractive power, a second lens group G2 having a positive refractive power, and a third lens group G3 having a negative refractive power. Note that the objective 5 is a liquid immersion objective for microscope.

The first lens group G1 includes, in order from the object side, a cemented lens CL1, and a lens L3 which is a meniscus lens having a concave surface facing the object side. The cemented lens CL1 is a two-piece cemented lens and is formed of, in order from the object side, a lens L1 which is a plano-convex lens having a flat surface facing the object side and a lens L2 which is a meniscus lens having a concave surface facing the object side.

The second lens group G2 converts a divergent pencil of light from the first lens group G1 into a convergent pencil of light. The second lens group G2 includes, in order from the object side, a lens L4 which is a biconvex lens, a cemented lens CL2 which is a three-piece cemented lens, and a cemented lens CL3 which is a two-piece cemented lens. The cemented lens CL2 is a positive-negative-positive three-piece cemented lens, and is formed of, in order from the object side, a lens L5 which is a biconvex lens, a lens L6 which is a biconcave lens, and a lens L7 which is a biconvex lens. The cemented lens CL3 is a moving group and is formed of, in order from the object side, a lens L8 which is a meniscus lens having a concave surface facing the image side and a lens L9 which is a biconvex lens.

The third lens group G3 is formed of a front group FG (cemented lens CL4) and a back group BG (cemented lens CL5 and lens L14) having concave surfaces facing each other. The third lens group G3 includes, in order from the object side, a cemented lens CL4, a cemented lens CL5, and a lens L14 which is a meniscus lens having a concave surface facing the object side. The cemented lens CL4 is formed of, in order from the object side, a lens L10 which is a biconvex lens and a lens L11 which is a biconcave lens. The cemented lens CL5 is formed of, in order from the object side, a lens L12 which is a biconcave lens and a lens L13 which is a biconvex lens.

Various data of the objective 5 are as follows.

β≈30, f=6.0033 mm (first state), f=5.9797 mm (second state), f1=10.9856 mm, f2=17.9133 mm, f3=−42.1456 mm, NA=1.00, WD=0.850 mm (first state), WD=0.796 mm (second state), iνd1=52.02, iνd2=55.38, νdG1=67.720, νdG2=40.760, R1=−1.5200 mm, νdZ1=94.66, νdZ2=42.41, FZ1=132.759 mm

(first state) TANF=0.1335, TANC=0.1359, TANd=0.1353

(second state) TANF=0.1336, TANC=0.1354, TANd=0.1350

Lens data of the objective 5 is as follows.

Objective Lens 5

| s | r | d | nd | νd |
|---|---|---|---|---|
| 1 | INF | 0.1700 | 1.52397 | 54.41 |
| 2 | INF | D2 | NE2 | νD2 |
| 3 | INF | 0.9000 | 1.45847 | 67.72 |
| 4 | −1.5200 | 4.5127 | 1.88300 | 40.76 |
| 5 | −4.9150 | 0.1500 | | |
| 6 | −34.0286 | 2.3254 | 1.56907 | 71.30 |
| 7 | −9.7099 | 0.1500 | | |
| 8 | 43.2968 | 2.5557 | 1.56907 | 71.30 |
| 9 | −20.7428 | 0.2500. | | |
| 10 | 48.4359 | 7.9845 | 1.56907 | 71.30 |
| 11 | −10.6748 | 0.8000 | 1.83481 | 42.73 |
| 12 | 39.2160 | 3.8527 | 1.56907 | 71.30 |
| 13 | −13.4694 | D13 | | |
| 14 | 41.7232 | 0.8000 | 1.63775 | 42.41 |
| 15 | 7.4012 | 5.5485 | 1.43875 | 94.66 |
| 16 | −24.0185 | D16 | | |
| 17 | 6.3397 | 5.0585 | 1.43875 | 94.66 |
| 18 | −88.5427 | 0.6873 | 1.63775 | 42.41 |
| 19 | 4.7166 | 4.2500 | | |
| 20 | −4.7551 | 0.7000 | 1.63775 | 42.41 |
| 21 | 29.7899 | 2.7115 | 1.43875 | 94.66 |
| 22 | −19.7566 | 0.3098 | | |
| 23 | −27.6274 | 3.6172 | 1.73800 | 32.33 |
| 24 | −8.6200 | 120.0000 | | |

Surfaces indicated by surface numbers s1 and s2 are an object-side surface of a cover glass CG and an image-side surface of the cover glass CG, respectively. Surfaces indicated by surface numbers s3 and s24 are a lens surface closest to the object side and a lens surface closest to the image side of the objective 5, respectively.

The values D2, D13 and D16 of the surface spacings d2, d13 and d16 in the first state illustrated in FIG. 26 in which the immersion liquid (immersion liquid B) having ND2=1.40420 and νD2=52.02 is used, and in the second state illustrated in FIG. 27 in which the immersion liquid (immersion liquid C) having ND2=1.33276 and νD2=55.38 is used are as follows. The refractive index ratio (minimum/maximum) of these immersion liquids is 0.949, and the Abbe number ratio (minimum/maximum) is 0.939. In this example, both the refractive indices and the Abbe numbers of the immersion liquids differ by 5% or more.

| | First State | Second State |
|---|---|---|
| D2 | 0.8500 | 0.7964 |
| D13 | 1.0857 | 0.2947 |
| D16 | 0.2931 | 1.0841 |

The objective 5 satisfies the conditional expressions (1) to (5) as illustrated below.

first state: NA×WD=0.850 mm (1)

second state: NA×WD=0.796 mm (1)

first state: 1/|(iνd1−iνd2)×WD|=0.350 mm⁻¹ (2)

second state: 1/|(iνd1−iνd2)×WD|=0.374 mm⁻¹ (2)

(νdG1−νdG2)/R1=−17.737 mm⁻¹ (3)

first state: |(TANF−TANC)/TANd|=0.0180 (4)

second state: |(TANF−TANC)/TANd|=0.0139 (4)

(νdZ1−νdZ2)/FZ1=0.394 mm⁻¹ (5)

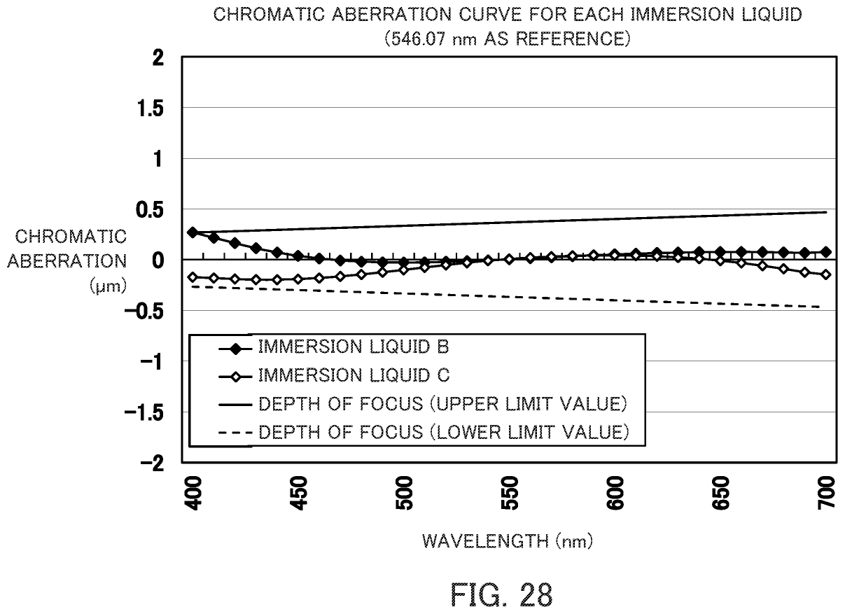

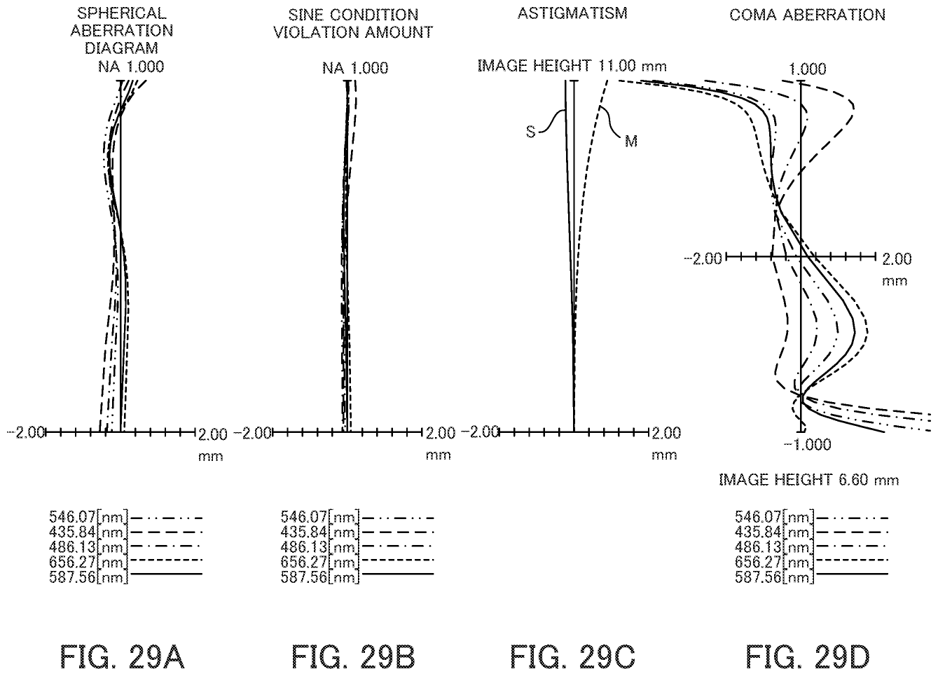

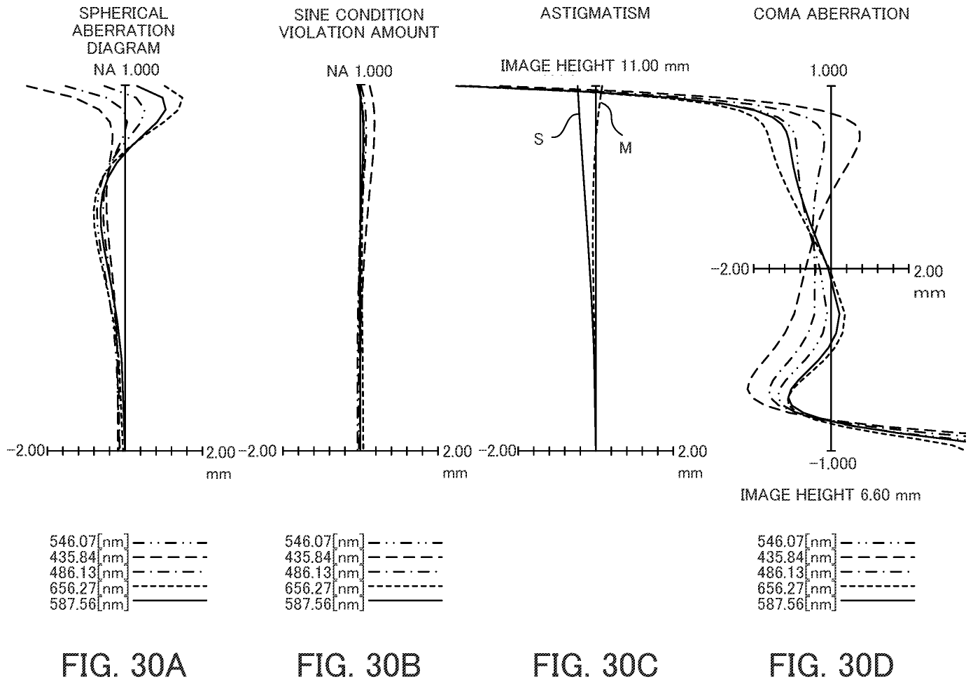

FIG. 28 is a graph illustrating the amount of chromatic aberration of the optical system formed of the objective 5 and the tube lens 10. FIGS. 29A to 29D and FIGS. 30A to 30D are aberration diagrams of the optical system formed of the objective 5 and the tube lens 10, and illustrate aberrations on the image plane formed by the objective 5 and the tube lens 10 in the first state and the second state, respectively. FIGS. 29A and 30A are spherical aberration diagrams, FIGS. 29B and 30B are diagrams illustrating sine condition violation amounts, FIGS. 29C and 30C are astigmatism diagrams, and FIGS. 29D and 30D are coma aberration diagrams.

As illustrated in FIG. 28, in the objective 5, the chromatic aberration is within depth of focus over a wide wavelength range. As illustrated in FIGS. 29A to 29D and FIGS. 30A to 30D, in the present embodiment, each aberration is satisfactorily corrected.

### Sixth Embodiment

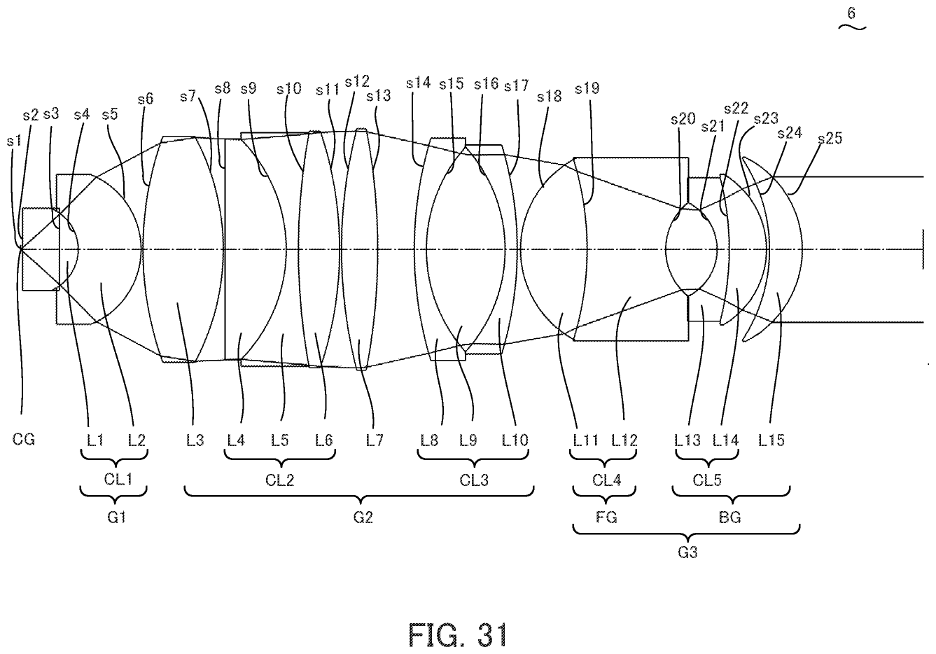

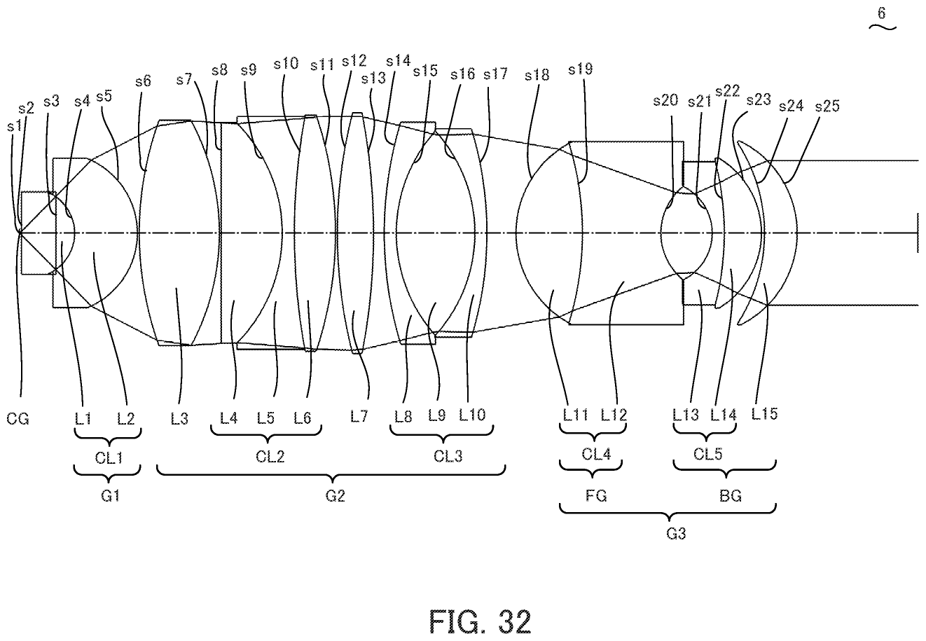

FIGS. 31 and 32 are cross-sectional views of an objective 6 according to the present embodiment. FIGS. 31 and 32 illustrate states in which the positions of the moving groups in the objective 6 are different from each other. In the present embodiment, the states illustrated in FIGS. 31 and 32 are referred to as a first state and a second state, respectively.

The objective 6 is formed of, in order from the object side, a first lens group G1 having a positive refractive power, a second lens group G2 having a positive refractive power, and a third lens group G3 having a negative refractive power. Note that the objective 6 is a liquid immersion objective for microscope.

The first lens group G1 is formed of a cemented lens CL1. The cemented lens CL1 is a two-piece cemented lens and is formed of, in order from the object side, a lens L1 which is a plano-convex lens having a flat surface facing the object side and a lens L2 which is a meniscus lens having a concave surface facing the object side.

The second lens group G2 converts a divergent pencil of light from the first lens group G1 into a convergent pencil of light. The second lens group G2 includes, in order from the object side, a lens L3 which is a biconvex lens, a cemented lens CL2 which is a three-piece cemented lens, a lens L7 which is a biconvex lens, and a cemented lens CL3 which is a three-piece cemented lens. The cemented lens CL2 is a positive-negative-positive three-piece cemented lens, and is formed of, in order from the object side, a lens L4 which is a biconvex lens, a lens L5 which is a biconcave lens, and a lens L6 which is a biconvex lens. The cemented lens CL3 is a moving group and is formed of, in order from the object side, a lens L8 which is a meniscus lens having a concave surface facing the image side, a lens L9 which is a biconvex lens, and a lens L10 which is a meniscus lens having a concave surface facing the object side.

The third lens group G3 is formed of a front group FG (cemented lens CL4) and a back group BG (cemented lens CL5 and lens L15) having concave surfaces facing each other. The third lens group G3 includes, in order from the object side, a cemented lens CL4, a cemented lens CL5, and a lens L15 which is a meniscus lens having a concave surface facing the object side. The cemented lens CL4 is formed of, in order from the object side, a lens L11 which is a biconvex lens and a lens L12 which is a biconcave lens. The cemented lens CL5 is formed of, in order from the object side, a lens L13 which is a meniscus lens having a concave surface facing the object side and a lens L14 which is a meniscus lens having a concave surface facing the object side.

Various data of the objective 6 are as follows.

β≈30, f=6.0037 mm (first state), f=5.9822 mm (second state), f1=16.9061 mm, f2=17.4760 mm, f3=−38.6087 mm, NA=1.00, WD=3.050 mm (first state), WD=2.854 mm (second state), iνd1=52.02, iνd2=52.67, νdG1=67.720, νdG2=40.760, R1=−3.7000 mm, νdZ1=94.66, νdZ2=54.68, FZ1=467.986 mm

(first state) TANF=0.1747, TANC=0.1761, TANd=0.1757

(second state) TANF=0.1739, TANC=0.1746, TANd=0.1745

Lens data of the objective 6 is as follows.

Objective Lens 6

| s | r | d | nd | νd |
|---|---|---|---|---|
| 1 | INF | 0.1700 | 1.52626 | 54.41 |
| 2 | INF | D2 | | |
| 3 | INF | 1.5443 | 1.46007 | 67.72 |
| 4 | −3.7000 | 5.1924 | 1.88815 | 40.76 |
| 5 | −6.6846 | 0.1500 | | |
| 6 | 27.3492 | 6.6359 | 1.57098 | 71.30 |
| 7 | −19.7403 | 0.1500 | | |
| 8 | 9236.1801 | 5.0524 | 1.43986 | 94.66 |
| 9 | −12.9085 | 1.0000 | 1.64132 | 42.41 |
| 10 | 53.7229 | 3.4076 | 1.43986 | 94.66 |
| 11 | −30.7304 | 0.1500 | | |
| 12 | 39.8749 | 3.0000 | 1.57098 | 71.30 |
| 13 | −52.7232 | D13 | | |
| 14 | 31.6649 | 1.0000 | 1.73234 | 54.68 |
| 15 | 12.6904 | 6.5041 | 1.43986 | 94.66 |
| 16 | −12.5569 | 1.0000 | 1.73234 | 54.68 |
| 17 | −29.7362 | D17 | | |
| 18 | 8.5032 | 5.5038 | 1.43986 | 94.66 |
| 19 | −25.2886 | 6.4884 | 1.64132 | 42.41 |
| 20 | 4.9763 | 4.2500 | | |
| 21 | −4.3237 | 1.0000 | 1.88815 | 40.76 |
| 22 | −23.9942 | 3.0751 | 1.43986 | 94.66 |
| 23 | −7.2364 | 0.2533 | | |
| 24 | −13.6517 | 2.7031 | 1.85694 | 30.05 |
| 25 | −8.5047 | 120.0000 | | |

Surfaces indicated by surface numbers s1 and s2 are an object-side surface of a cover glass CG and an image-side surface of the cover glass CG, respectively. Surfaces indicated by surface numbers s3 and s25 are a lens surface closest to the object side and a lens surface closest to the image side of the objective 6, respectively.

The values D2, D13 and D17 of the surface spacings d2, d13 and d17 in the first state illustrated in FIG. 31 in which the immersion liquid (immersion liquid A) having ND2=1.49306 and νD2=52.67 is used, and in the second state illustrated in FIG. 32 in which the immersion liquid (immersion liquid B) having ND2=1.40420 and νD2=52.02 is used are as follows. The refractive index ratio (minimum/maximum) of these immersion liquids is 0.940, and the Abbe number ratio (minimum/maximum) is 0.988. In this example, the refractive indices of the immersion liquids differ by 5% or more.

| | First State | Second State |
|---|---|---|
| D2 | 3.0500 | 2.8539 |
| D13 | 3.0138 | 0.8812 |
| D17 | 0.2683 | 2.4009 |

The objective 6 satisfies the conditional expressions (1) to (4) as illustrated below.

first state: NA×WD=3.050 mm (1)

second state: NA×WD=2.854 mm (1)

first state: 1/|(iνd1−iνd2)×WD|=0.504 mm⁻¹ (2)

second state: 1/|(iνd1−iνd2)×WD|=0.539 mm⁻¹ (2)

(νdG1−νdG2)/R1=−7.286 mm⁻¹ (3)

first state: |(TANF−TANC)/TANd|=0.0079 (4)

second state: |(TANF−TANC)/TANd|=0.0040 (4)

(νdZ1−νdZ2)/FZ1=0.085 mm⁻¹ (5)

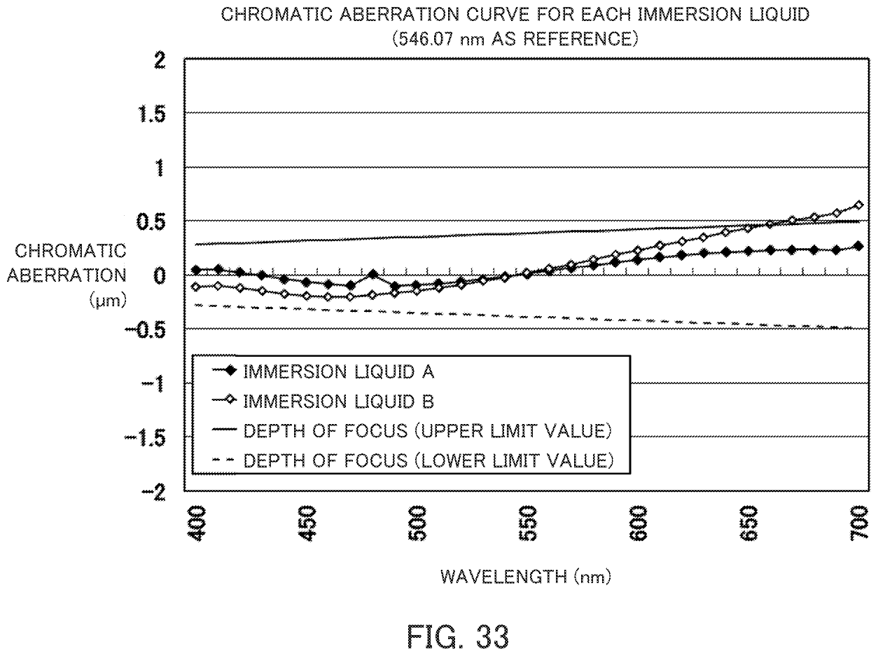

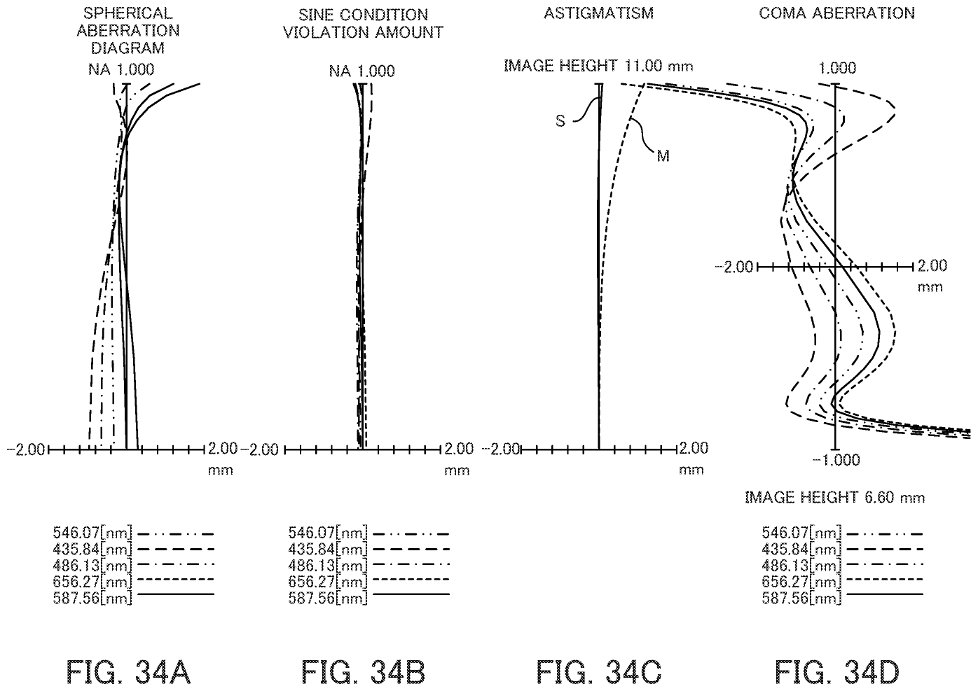

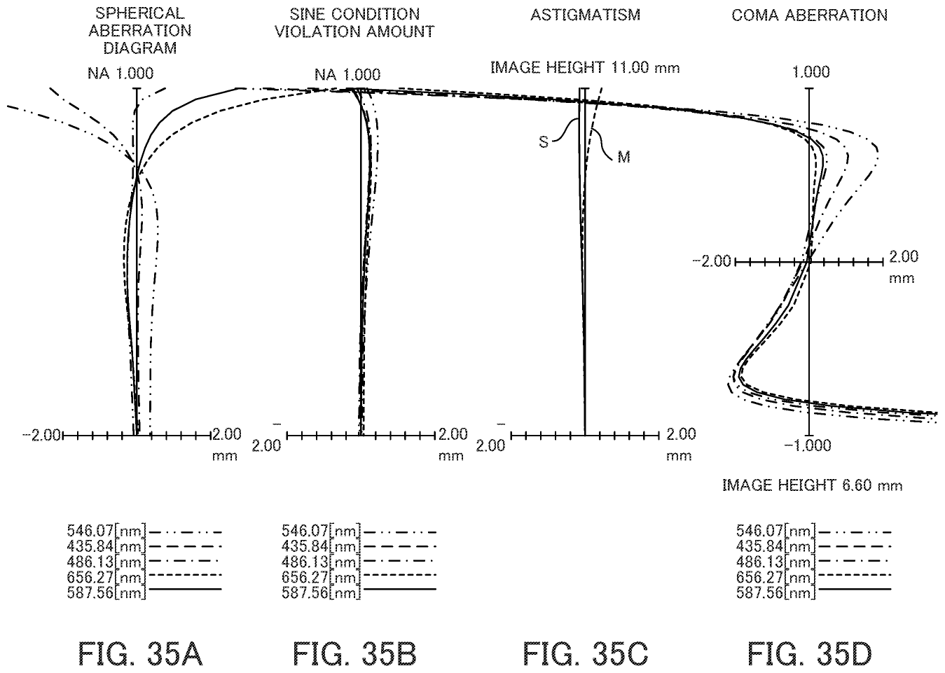

FIG. 33 is a graph illustrating the amount of chromatic aberration of the optical system formed of the objective 6 and the tube lens 10. FIGS. 34A to 34D and FIGS. 35A to 35D are aberration diagrams of the optical system formed of the objective 6 and the tube lens 10, and illustrate aberrations on the image plane formed by the objective 6 and the tube lens 10 in the first state and the second state, respectively. FIGS. 34A and 35A are spherical aberration diagrams, FIGS. 34B and 35B are diagrams illustrating sine condition violation amounts, FIGS. 34C and 35C are astigmatism diagrams, and FIGS. 34D and 35D are coma aberration diagrams.

As illustrated in FIG. 33, in the objective 6, the chromatic aberration is within depth of focus over a wide wavelength range. As illustrated in FIGS. 34A to 34D and FIGS. 35A to 35D, in the present embodiment, each aberration is satisfactorily corrected.

### Seventh Embodiment

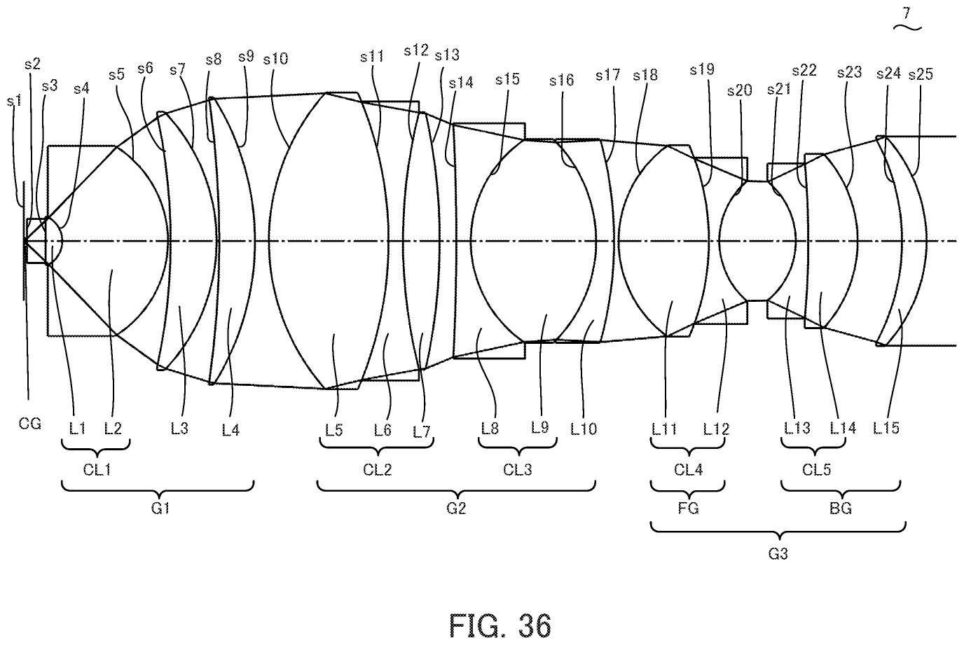

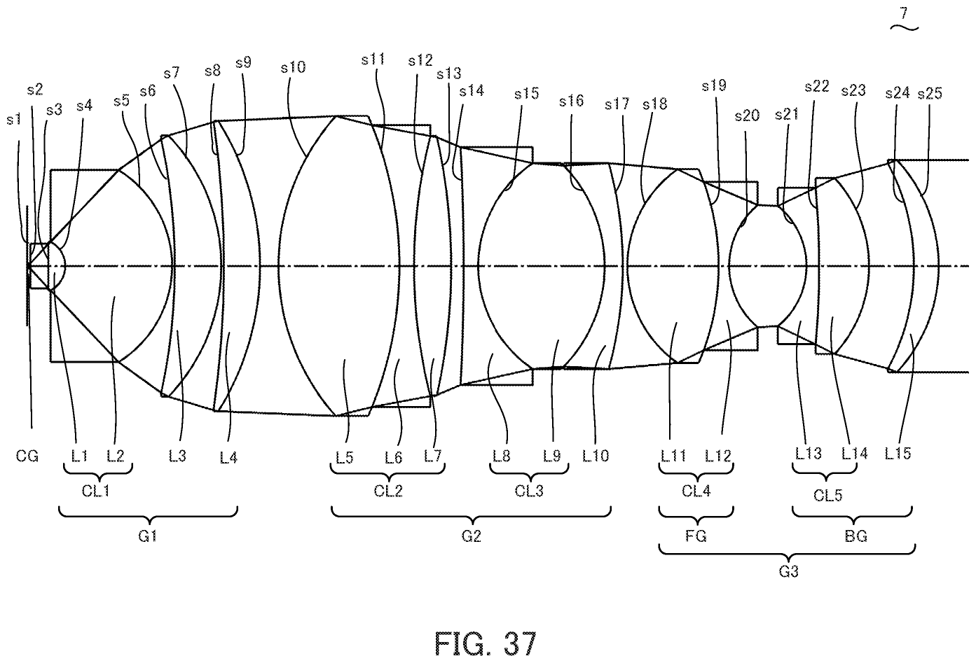

FIGS. 36 and 37 are cross-sectional views of an objective 7 according to the present embodiment. FIGS. 36 and 37 illustrate states in which the positions of the moving groups in the objective 7 are different from each other. In the present embodiment, the states illustrated in FIGS. 36 and 37 are referred to as a first state and a second state, respectively.

The objective 7 is formed of, in order from the object side, a first lens group G1 having a positive refractive power, a second lens group G2 having a positive refractive power, and a third lens group G3 having a negative refractive power. Note that the objective 7 is a liquid immersion objective for microscope.

The first lens group G1 includes a cemented lens CL1, a lens L3 which is a meniscus lens having a concave surface facing the object side, and a lens L4 which is a meniscus lens having a concave surface facing the object side. The cemented lens CL1 is a two-piece cemented lens and is formed of, in order from the object side, a lens L1 which is a plano-convex lens having a flat surface facing the object side and a lens L2 which is a meniscus lens having a concave surface facing the object side.

The second lens group G2 converts a divergent pencil of light from the first lens group G1 into a convergent pencil of light. The second lens group G2 includes, in order from the object side, a cemented lens CL2 which is a moving group and a cemented lens CL3 which is a three-piece cemented lens. The cemented lens CL2 is a positive-negative-positive three-piece cemented lens. The cemented lens CL2 is formed of, in order from the object side, a lens L5 which is a biconvex lens, a lens L6 which is a biconcave lens, and a lens L7 which is a biconvex lens. The cemented lens CL3 is formed of, in order from the object side, a lens L8 which is a biconcave lens, a lens L9 which is a biconvex lens, and a lens L10 which is a meniscus lens having a concave surface facing the object side.

The third lens group G3 is formed of a front group FG (cemented lens CL4) and a back group BG (cemented lens CL5 and lens L15) having concave surfaces facing each other. The third lens group G3 includes, in order from the object side, a cemented lens CL4, a cemented lens CL5, and a lens L15 which is a meniscus lens having a concave surface facing the object side. The cemented lens CL4 is formed of, in order from the object side, a lens L11 which is a biconvex lens and a lens L12 which is a biconcave lens. The cemented lens CL5 is formed of, in order from the object side, a lens L13 which is a meniscus lens having a concave surface facing the object side and a lens L14 which is a meniscus lens having a concave surface facing the object side.

Various data of the objective 7 are as follows.

β≈30, f=5.6500 mm (first state), f=5.7216 mm (second state), f1=8.1812 mm, f2=19.0924 mm, f3=−23.5805 mm, NA=1.03, WD=1.043 mm (first state), WD=0.998 mm (second state), iνd1=52.02, iνd2=55.50, νdG1=64.140, νdG2=40.760, R1=−1.5220 mm, νdZ1=81.54, νdZ2=42.41, FZ1=23.666 mm

(first state) TANF=0.4106, TANC=0.4086, TANd=0.4092

(second state) TANF=0.4229, TANC=0.4213, TANd=0.4217

Lens data of the objective 7 is as follows.

Objective Lens 7

| s | r | d | nd | νd |
|---|---|---|---|---|
| 1 | INF | 0.1700 | 1.52397 | 54.41 |
| 2 | INF | D2 | | |
| 3 | INF | 0.9200 | 1.51633 | 64.14 |
| 4 | −1.5220 | 5.8724 | 1.88300 | 40.76 |
| 5 | −6.2118 | 0.1500 | | |
| 6 | −32.8721 | 2.5527 | 1.56907 | 71.30 |
| 7 | −10.3408 | 0.1500 | | |
| 8 | −55.7457 | 1.9842 | 1.56907 | 71.30 |
| 9 | −15.0584 | D9 | | |
| 10 | 12.3872 | 6.6514 | 1.49700 | 81.54 |
| 11 | −20.7313 | 0.8000 | 1.63775 | 42.41 |
| 12 | 28.8979 | 2.0473 | 1.49700 | 81.54 |
| 13 | −32.6014 | D13 | | |
| 14 | −122.6663 | 0.8000 | 1.63775 | 42.41 |
| 15 | 6.8328 | 6.9659 | 1.43875 | 94.66 |
| 16 | −7.9309 | 1.0000 | 1.63775 | 42.41 |
| 17 | −21.1257 | 0.2500 | | |
| 18 | 6.5364 | 5.0213 | 1.56907 | 71.30 |
| 19 | −13.4525 | 0.5766 | 1.63775 | 42.41 |
| 20 | 4.3905 | 4.2500 | | |
| 21 | −4.2715 | 0.7000 | 1.88300 | 40.76 |
| 22 | −46.7342 | 2.7417 | 1.74100 | 52.64 |
| 23 | −7.1494 | 2.4643 | | |
| 24 | −11.8812 | 1.3602 | 1.85478 | 24.80 |
| 25 | −8.5760 | 120.0000 | | |

Surfaces indicated by surface numbers s1 and s2 are an object-side surface of a cover glass CG and an image-side surface of the cover glass CG, respectively. Surfaces indicated by surface numbers s3 and s25 are a lens surface closest to the object side and a lens surface closest to the image side of the objective 7, respectively.

The values D2, D9 and D13 of the surface spacings d2, d9 and d13 in the first state illustrated in FIG. 36 in which the immersion liquid (immersion liquid E) having ND2=1.49306 and νD2=55.50 is used, and in the second state illustrated in FIG. 37 in which the immersion liquid (immersion liquid B) having ND2=1.40420 and νD2=52.02 is used are as follows. The refractive index ratio (minimum/maximum) of these immersion liquids is 0.940, and the Abbe number ratio (minimum/maximum) is 0.937. In this example, both the refractive indices and the Abbe numbers of the immersion liquids differ by 5% or more.

| | First State | Second State |
|---|---|---|
| D2 | 1.0428 | 0.9981 |
| D9 | 0.7740 | 1.0120 |
| D13 | 0.9260 | 0.6880 |

The objective 7 satisfies the conditional expressions (1) to (5) as illustrated below.

first state: NA×WD=1.074 mm (1)

second state: NA×WD=1.028 mm (1)

first state: 1/|(iνd1−iνd2)×WD|=0.276 mm⁻¹ (2)

second state: 1/|(iνd1−iνd2)×WD|=0.288 mm⁻¹ (2)

(νdG1−νdG2)/R1=−15.361 mm⁻¹ (3)

first state: |(TANF−TANC)/TANd|=0.0048 (4)

second state: |(TANF−TANC)/TANd|=0.0038 (4)

(νdZ1−νdZ2)/FZ1=1.653 mm⁻¹ (5)

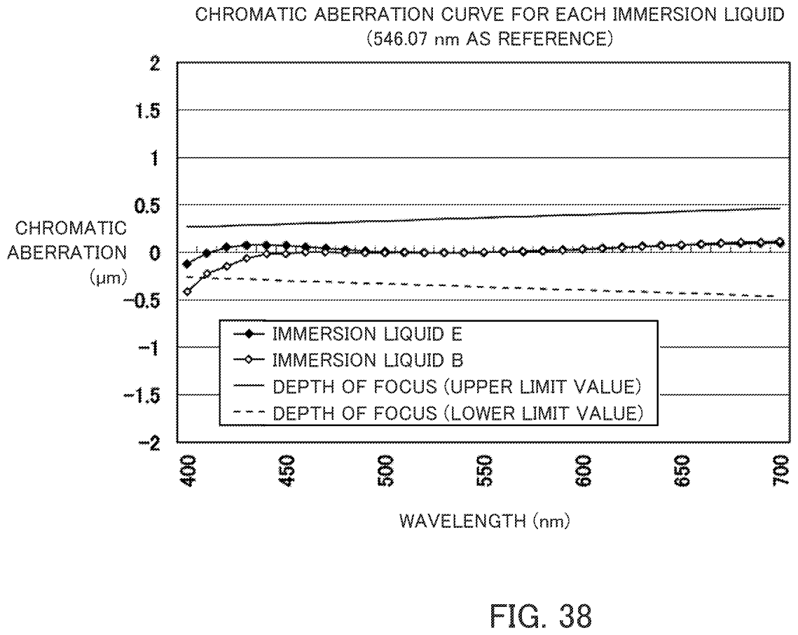

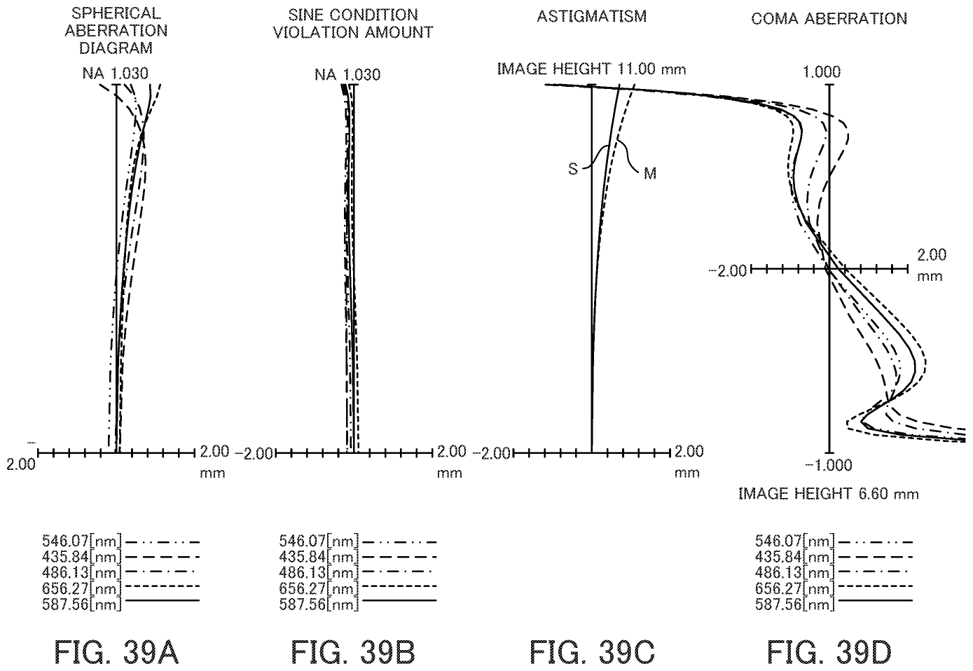

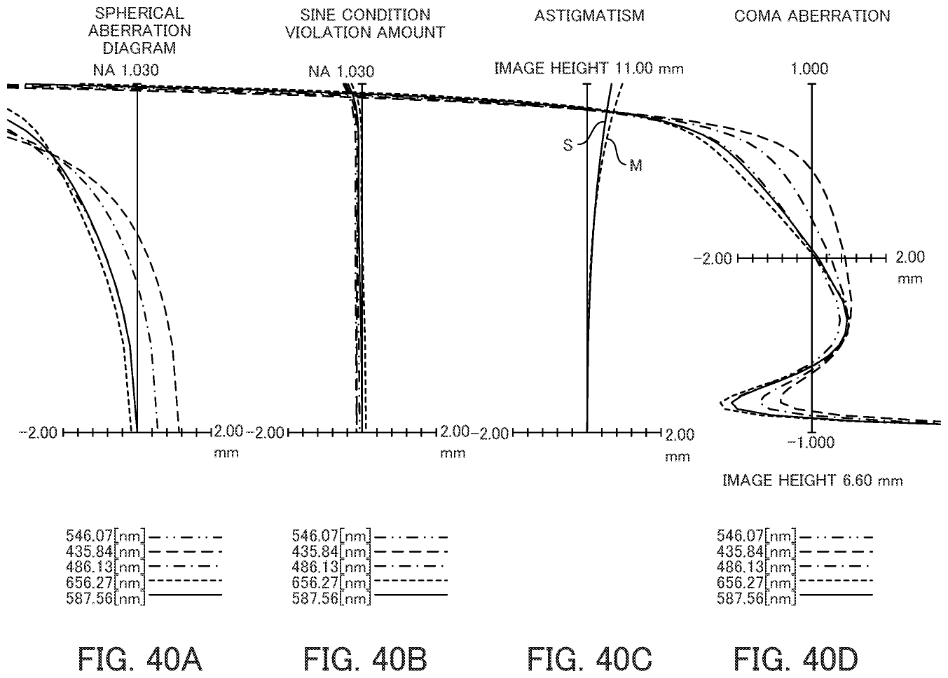

FIG. 38 is a graph illustrating the amount of chromatic aberration of an optical system formed of the objective 7 and the tube lens 10. FIGS. 39A to 39D and FIGS. 40A to 40D are aberration diagrams of the optical system formed of the objective 7 and the tube lens 10, and illustrate aberrations on the image plane formed by the objective 7 and the tube lens 10 in the first state and the second state, respectively. FIGS. 39A and 40A are spherical aberration diagrams, FIGS. 39B and 40B are diagrams illustrating sine condition violation amounts, FIGS. 39C and 40C are astigmatism diagrams, and FIGS. 39D and 40D are coma aberration diagrams.

As illustrated in FIG. 38, in the objective 7, the chromatic aberration is within depth of focus over a wide wavelength range. As illustrated in FIGS. 39A to 39D and FIGS. 40A to 40D, in the present embodiment, each aberration is satisfactorily corrected.

What is claimed is:

1. An immersion microscope objective having a magnification of 35 times or less, the immersion microscope objective comprising, in order from an object side:
a first lens group including a meniscus lens;
a second lens group including a cemented lens and having a positive refractive power for converting a divergent pencil of light into a convergent pencil of light; and
a third lens group having a negative refractive power, wherein
the third lens group is formed of, in order from the object side:
a front group having a concave surface having a negative refractive power on a most image side; and
a back group having a concave surface having a negative refractive power on the most object side,
even when any of a plurality of immersion liquids used together with the immersion microscope objective is used, an amount of chromatic aberration at each of wavelengths in a range from 435.18 nm to 656.13 nm, which has an e-line as a reference, is smaller than a magnitude of depth of focus of the immersion microscope objective at the wavelength, and
a following conditional expression is satisfied:
0.64≤NA×WD≤3.5 (1)
where NA is a numerical aperture on the object side of the immersion microscope objective, and WD is a working distance of the immersion microscope objective.

2. The immersion microscope objective according to claim 1, wherein only one moving group is included in any one of the first lens group, the second lens group, and the third lens group.

3. The immersion microscope objective according to claim 2, wherein a following conditional expression is satisfied:
0.25≤1/|(iνd1−iνd2)×WD|≤10 [mm⁻¹] (2)
where iνd1 is an Abbe number of an immersion liquid having the lowest refractive index among the plurality of immersion liquids used together with the immersion microscope objective, and iνd2 is an Abbe number of an immersion liquid having the highest refractive index among the plurality of immersion liquids used together with the immersion microscope objective.

4. The immersion microscope objective according to claim 2, wherein
the first lens group includes a cemented lens on the most object side,
the cemented lens included in the first lens group includes, from the object side, a first lens and the meniscus lens, and is a two-piece cemented lens in which the first lens and the meniscus lens are cemented, and
a following conditional expression is satisfied:
−20≤(νdG1−νdG2)/R1≤−5 [mm⁻¹] (3)
where νdG1 is an Abbe number of the first lens, and νdG2 is an Abbe number of the meniscus lens.

5. The immersion microscope objective according to claim 3, wherein
the first lens group includes a cemented lens on the most object side,
the cemented lens included in the first lens group includes, from the object side, a first lens and the meniscus lens, and is a two-piece cemented lens in which the first lens and the meniscus lens are cemented, and
a following conditional expression is satisfied:
−20≤(νdG1−νdG2)/R1≤−5 [mm⁻¹] (3)
where νdG1 is an Abbe number of the first lens, and νdG2 is an Abbe number of the meniscus lens.

6. The immersion microscope objective according to claim 4, wherein
the back group has at least one air contact surface between a lens surface closest to the object side and a lens surface closest to the image side of the back group, and
a following conditional expression is satisfied:
0.003≤|(TANF−TANC)/TANd|≤0.020 (4)
where TANF is a ratio of a longitudinal direction cosine to a transverse direction cosine of an axial marginal ray for an F-line and is a tangent indicating a direction at a time of emission from a lens surface closest to the image side of the moving group, TANC is a ratio of a longitudinal direction cosine to a transverse direction cosine of an axial marginal ray for a C-line and is a tangent indicating a direction at a time of emission from a lens surface closest to the image side of the moving group, and TANd is a ratio of a longitudinal direction cosine to a transverse direction cosine of an axial marginal ray for a d-line and is a tangent indicating a direction at a time of emission from a lens surface closest to the image side of the moving group.

7. The immersion microscope objective according to claim 5, wherein
the back group has at least one air contact surface between a lens surface closest to the object side and a lens surface closest to the image side of the back group, and
a following conditional expression is satisfied:
0.003≤|(TANF−TANC)/TANd|≤0.020 (4)
where TANF is a ratio of a longitudinal direction cosine to a transverse direction cosine of an axial marginal ray for an F-line and is a tangent indicating a direction at a time of emission from a lens surface closest to the image side of the moving group, TANC is a ratio of a longitudinal direction cosine to a transverse direction cosine of an axial marginal ray for a C-line and is a tangent indicating a direction at a time of emission from a lens surface closest to the image side of the moving group, and TANd is a ratio of a longitudinal direction cosine to a transverse direction cosine of an axial marginal ray for a d-line and is a tangent indicating a direction at a time of emission from a lens surface closest to the image side of the moving group.

8. The immersion microscope objective according to claim 6, wherein
the moving group is a cemented lens, and
a following conditional expression is satisfied:
0.3≤(νdZ1−νdZ2)/FZ1≤3 [mm⁻¹] (5)
Where νdZ1 is a highest Abbe number among Abbe numbers of one or more positive lenses included in the moving group, νdZ2 is a lowest Abbe number among Abbe numbers of one or more negative lenses included in the moving group, and FZ1 is a focal length of the moving group.

9. The immersion microscope objective according to claim 7, wherein
the moving group is a cemented lens, and
a following conditional expression is satisfied:
0.3≤(νdZ1−νdZ2)/FZ1≤3 [mm⁻¹] (5)
where νdZ1 is a highest Abbe number among Abbe numbers of one or more positive lenses included in the moving group, νdZ2 is a lowest Abbe number among Abbe numbers of one or more negative lenses included in the moving group, and FZ1 is a focal length of the moving group.

10. The immersion microscope objective according to claim 8, wherein the second lens group includes a plurality of cemented lenses.

11. The immersion microscope objective according to claim 9, wherein the second lens group includes a plurality of cemented lenses.

12. The immersion microscope objective according to claim 10, wherein the plurality of cemented lenses includes a positive-negative-positive three-piece cemented lens.

13. The immersion microscope objective according to claim 11, wherein the plurality of cemented lenses includes a positive-negative-positive three-piece cemented lens.
